(19) United States
(12) Patent Application Publication
(10) Pub. No.: US 2022/0051864 A1
(43) Pub. Date: Feb. 17, 2022

(54) Breaker Plug, Network Systems and Methods

(71) Applicants: Daniel J. Daoura, Renton, WA (US); Kal K. Lambert, Hammond, OR (US)

(72) Inventors: Daniel J. Daoura, Renton, WA (US); Kal K. Lambert, Hammond, OR (US)

(21) Appl. No.: 17/467,203

(22) Filed: Sep. 4, 2021

Related U.S. Application Data
(63) Continuation-in-part of application No. 17/144,106, filed on Jan. 7, 2021, now Pat. No. 11,139,640.
(60) Provisional application No. 62/963,119, filed on Jan. 19, 2020.

(51) Int. Cl. H01H 71/02; H01H 71/12; H01H 71/10; H02B 1/056; H01H 83/20; H01H 83/02; H01R 13/713; H01R 24/76

(52) U.S. Cl. CPC H01H 71/0271; H01H 71/12; H01H 71/1009; H02B 1/056; H01H 2071/467; H01H 83/02; H01R 13/7135; H01R 24/76; H01H 83/20

(57) ABSTRACT

A device with “plug-in” receptacle that mounts in a breaker panel. The plug receptacle receives a power cord inserted by the operator. The device includes a multifunction circuit interrupt that offers overload, thermal, and ground fault (GFCI) protection for the operator in hazardous environments such as garages, shops and spider boxes at construction sites. The devices may include a networkable node or port and onboard comm circuitry that is compatible with a wired or wireless TOT network. In another embodiment, a dummy breaker body includes a plug receptacle with a GFCI interrupt circuit but no direct electrical connection to the hot bus bar, and is wired in series with a conventional circuit breaker module in a breaker panel. Using solid state electronics, the GFCI panel-mounted devices may be configured to perform an automatic fault test prior to each use. Network systems using smart breaker devices are described.

### CROSS REFERENCE TO RELATED APPLICATIONS

This application is a Continuation-in-Part of U.S. patent Ser. No. 17/144,106 entitled “Breaker Plug”, now U.S. patent Ser. No. ______, which is related to and claims priority to U.S. Provisional Patent Ser. No. 62/963,119 entitled “Breaker Plug,” filed Jan. 19, 2020. All said patent documents are incorporated in full by reference for all purposes.

### TECHNICAL FIELD

This disclosure pertains generally to the field of solutions for accessing AC electrical power from a breaker panel.

### BACKGROUND

A solution to the problem of tapping power directly from a breaker panel is addressed that overcomes the need to install a conventional plug receptacle outside the breaker panel, while not creating an unsafe condition. Because breaker panels are sometimes situated in temporary structures or in garages, for example, where wetness and grounded surfaces are common, there is a need for a ground fault interrupt at the level of the breaker panel. The problem is of interest to homebuilders, tradespersons, and hobbyists and has general interest in industries where AC electrical power is used.

### SUMMARY

Disclosed in a first embodiment is a “circuit breaker/plug” combination, which comprises, in a single unit, a circuit breaker body with multifunction breaker plus a plug receptacle in series, and is designed to be mounted inside a breaker panel. The circuit breaker is configured to be connectedly mounted to a hot bus bar in a breaker panel and the plug receptacle is configured to receive a detachable cord-mounted plug for conveying alternating current to an appliance or tool in need of power. The circuit breaker/plug unit may be affixed in the breaker panel on a rail, clips to the power supply as standard for the country of use, and conforms to a modular standard so as to be interchangeable with other circuit breaker units.

Combination circuit breaker/plug receptacle devices are configured to comply with standards for use in domestic and industrial breaker panels. The modular devices snap into place on hot shoes or on a hot rail of a bus bar and may be removed when not in use—or may be permanently installed without causing mechanical interference with the breaker panel door. When the breaker panel door is closed, the combination devices are not in use. In variants of the invention, models compatible with 120 VAC, 240 VAC and 480 VAC, single phase and three phase may be provided with receptacles/adaptors for receiving mating electrical cords. The circuit breakers may be calibrated according to accepted ratings from 15 Amp to 20 Amp to 50 Amp or higher. Circuit overload breakers are standard. GFI models are provided in which the GFCI circuit is connected to the plug receptacle for monitoring current in the hot and neutral outputs. Safety is not sacrificed when operating tools or appliances connected directly from within a breaker panel.

Disclosed in a second embodiment is a device having a modular dummy circuit breaker body which comprises a plug receptacle—but no working circuit breaker and no direct connection to the hot bus bar. The modular dummy breaker body seats on the hot bus bar in a breaker panel in the same way as a conventional circuit breaker, but does not receive power via a hot shoe in the base of the body, and is wired instead in series with an adjacent genuine circuit breaker. Advantageously, in this embodiment, the circuit breaker body is a conventional assembly, but is wired in series with the dummy breaker body so that the plug receptacle can be used while protected by the circuit breaker from overload, short, or overheating, for example. The two body units are wired separately and may sit crosswise (head-to-head) or side-by-side within the breaker panel. If side-by-side, the “single-wide” bodies (each modular unit width defining a standard width) may be contacted at an opposing lateral wall and are wired as a “double-wide” pair of modular units in the breaker panel such that a lateral wall of the circuit breaker rests beside a lateral wall of the dummy breaker body. Alternatively, the two body units may be wired in a trans-position in which the body units sit head-to-head in the breaker panel, the hot wire from the circuit breaker extends to the dummy breaker plug body, and the neutral or common wire runs from the dummy breaker plug body to the neutral or common bus bar and is grounded to a ground strap or bus within the breaker panel. The dummy breaker body will include a GFCI circuit interrupt so that the combination of circuit breaker plus plug receptacle in series has overload, thermal and ground fault interrupt breaker functions.

By adding networking capacity, the device(s) can be monitored remotely. By adding a battery and memory, event records can be stored locally and are available to a technician during servicing. By using solid state breaker elements, the devices can include automated testing and reset during down time or at programmed intervals.

The device may also be provided with a coverpanel, that seats over the faceplate of the device on top of the front “dead” coverpanel. The coverpanel may be a selectively radiotransparent material and may include a radio antenna. The device may couple to the antenna by an inductive link using NFC or resonance modulation radio amplification in the antenna. Alternatively the device may couple to the antenna by a stab connection that includes an earth ground plane.

The elements, features, steps, and advantages of one or more embodiments will be more readily understood upon consideration of the following detailed description, taken in conjunction with the accompanying drawings, in which embodiments, including details, conceptual elements, and current practices, are illustrated by way of example.

It is to be expressly understood, however, that the drawings are for illustration and description only and are not intended as a definition of the limits of the embodiments and conceptual basis as claimed. The various elements, features, steps, and combinations thereof that characterize aspects of the claimed matter are pointed out with particularity in the claims annexed to and forming part of this disclosure. The invention(s) do not necessarily reside in any one of these aspects taken alone, but rather in the invention(s) taken as a whole.

### BRIEF DESCRIPTION OF THE DRAWINGS

One or more embodiments are taught and are more readily understood by considering the drawings in association with the specification, in which:

FIG. 1A is view of a first breaker panel that includes a female plug receptacle mounted on the bus bars, shown here as dummy circuit breaker body with a plug receptacle for receiving a pluggable NEMA-type AC extension cord.

FIG. 1B is a detail view of a dummy breaker device that seats in the breaker panel, the dummy breaker including a female receptacle for receiving a pluggable AC extension cord. Conventional circuit breakers are shown for comparison.

FIG. 2A is a close-up view of a dummy breaker device with plug-in receptacle for receiving an AC plug.

FIGS. 2B and 2C are top and bottom isometric views of the dummy breaker with plug-in receptacle for receiving an AC plug.

FIG. 3A is a schematic showing the wiring of a dummy breaker device to a circuit breaker with magnetic fuse and thermal fuse, as is compatible with a conventional breaker panel and hot, neutral and ground rails. FIG. 3B is a schematic of a dummy breaker device with ground fault circuit interrupt (GFCI).

FIGS. 4A and 4B are perspective views of a dummy breaker body with wiring. In FIG. 4B, the dummy breaker is wired in series to a circuit breaker in a side-by-side “cis” position.

FIG. 5A is a view of a second breaker panel that includes a circuit breaker/plug receptacle, shown here as a female plug receptacle for receiving a pluggable aviation-type extension cord in a dummy breaker body in series with a circuit breaker. Both the dummy breaker body and the circuit breaker share a common modular body form.

FIG. 5B shows a dummy breaker body/aviation plug receptacle wired in series with a genuine circuit breaker.

FIG. 6A is a view of a dummy breaker body with aviation plug receptacle fitted for series wiring to a circuit breaker.

FIG. 6B shows a dummy breaker body with aviation plug receptacle in series with a circuit breaker.

FIG. 7 is a view of an adaptor with AC plug and a male aviation-type fitting that plugs into an aviation-type plug receptacle of a dummy breaker body wired in series with an AC circuit breaker.

FIG. 8 is a view of a 240 VAC plug assembly with two circuit breakers, double throw pole and series wiring to a dummy breaker with aviation-type receptacle.

FIGS. 9A, 9B, 9C, 9D, 9E and 9F are isometric and perspective views of a combination circuit breaker/plug body with plug receptacle as a single device.

FIG. 10 shows the combination circuit breaker/plug body in a context of use; here with an adaptor cord that converts a 4-pin male plug to a female NEMA 5-15 receptacle.

FIGS. 11A, 11B, 11C, and 11D are isometric and perspective views of a combination circuit breaker/plug body with 120 VAC NEMA 15-5 plug receptacle.

FIG. 12 shows the combination circuit breaker/plug device in a context of use.

FIG. 13 is a schematic of a circuit breaker/plug device wired for 3-phase applications.

FIG. 14 is a schematic showing a 480 VAC circuit breaker/plug receptacle and wiring.

FIGS. 15A and 15B are perspective and plan views, respectively, of a 240 VAC 3-phase circuit breaker/plug assembly.

FIG. 16 shows the three-pole circuit breaker/plug device in a context of use.

FIG. 17A shows a 4-pin aviation circular connector in plan view with numbered pin receptacles. The female plug end of the L16-30R AC-adaptor shown in FIG. 16 is drawn in plan view in FIG. 17B.

As suggested by FIG. 18, the circuit breaker/plug assembly may be modified to include any of a broad variety of plug receptacles known in the art.

Examples of various plugs according to country of use are shown in FIG. 19.

FIG. 20 is a graphical representation of various connectors, here showing receptacles according to the NEMA standards used commonly in the United States.

FIG. 21 is a view of single-keyway circular aviation connectors; the connectors have two to nine pin receptacles as commonly known and used.

FIGS. 22A and 22B are views of two adaptor cords having each a short cord with two distinct ends.

FIG. 23 is a view of a grounded circuit breaker/plug body and a “plug-in” 2-prong adaptor.

FIGS. 24A and 24B are perspective views of a modular circuit breaker/plug receptacle combination with user interface.

FIG. 25 is a schematic of a circuit breaker/plug receptacle device with ground fault circuit interrupt, user interface, optional datalink, and battery backup.

FIG. 26 is a schematic of a circuit breaker/plug receptacle device with ground fault circuit interrupt, user interface, and datalink.

FIGS. 27A and 27B are views of a modular circuit breaker/plug receptacle combination with solid state components.

FIG. 28 is a schematic with system for radio networking of a circuit breaker/plug receptacle combination.

FIG. 29 is a view showing a radio antenna mounted on a conventional modular circuit breaker for sharing data.

FIG. 30 is a system view of a bank of radio units configured to sense conditions of operation in a panel of circuit breakers and to report that data via a radio hub to a network host.

The drawing figures are not necessarily to scale. Certain features or components herein may be shown in somewhat schematic form and some details of conventional elements may not be shown in the interest of clarity, explanation, and conciseness. The drawing figures are hereby made part of the specification, written description and teachings disclosed herein.

### Glossary

Certain terms are used throughout the following description to refer to particular features, steps, or components, and are used as terms of description and not of limitation. As one skilled in the art will appreciate, different persons may refer to the same feature, step, or component by different names. Components, steps, or features that differ in name but not in structure, function, or action are considered equivalent and not distinguishable, and may be substituted herein without departure from the spirit and scope of this disclosure. The following definitions supplement those set forth elsewhere in this specification. Certain meanings are defined here as intended by the inventors, i.e., they are intrinsic meanings. Other words and phrases used herein take their meaning as consistent with usage as would be apparent to one skilled in the relevant arts. In case of conflict, the present specification, including definitions, will control.

Unless otherwise defined, all technical and scientific terms used herein have the same meaning as commonly understood by one of ordinary skill in the art to which the subject matter described herein belongs. In case of conflict, the present specification, including definitions, will control.

“Ground leakage” is the flow of current from a live conductor to the earth through the insulation. A ground fault circuit interrupt (GFCI) will detect ground leakage and trip a breaker if the leakage exceeds a threshold. GFCI circuits do not require a true earth ground to be functional, but the true earth ground helps protect against shocks from ground faults in the chassis of an appliance, for example.

General connection terms including, but not limited to “connected,” “attached,” “conjoined,” “secured,” and “affixed” are not meant to be limiting, such that structures so “associated” may have more than one way of being associated. “Fluidly connected” indicates a connection for conveying a fluid therethrough. “Digitally connected” indicates a connection in which digital data may be conveyed therethrough. “Electrically connected” indicates a connection in which units of electrical charge or power are conveyed therethrough.

Relative terms should be construed as such. For example, the term “front” is meant to be relative to the term “back,” the term “upper” is meant to be relative to the term “lower,” the term “vertical” is meant to be relative to the term “horizontal,” the term “top” is meant to be relative to the term “bottom,” and the term “inside” is meant to be relative to the term “outside,” and so forth. Unless specifically stated otherwise, the terms “first,” “second,” “third,” and “fourth” are meant solely for purposes of designation and not for order or for limitation. Reference to “one embodiment,” “an embodiment,” or an “aspect,” means that a particular feature, structure, step, combination or characteristic described in connection with the embodiment or aspect is included in at least one realization of the inventive matter disclosed here. Thus, the appearances of the phrases “in one embodiment” or “in an embodiment” in various places throughout this specification are not necessarily all referring to the same embodiment and may apply to multiple embodiments. Furthermore, particular features, structures, or characteristics of the inventive matter may be combined in any suitable manner in one or more embodiments. For example, it is contemplated that features of dependent claims depending from one independent claim can be used in apparatus and/or methods of any of the other independent claims.

“Adapted to” includes and encompasses the meanings of “capable of” and additionally, “designed to”, as applies to those uses intended by the patent. In contrast, a claim drafted with the limitation “capable of” also encompasses unintended uses and misuses of a functional element beyond those uses indicated in the disclosure. Aspex Eyewear v Marchon Eyewear 672 F3d 1335, 1349 (Fed Circ 2012). “Configured to”, as used here, is taken to indicate is able to, is designed to, and is intended to function in support of the inventive structures, and is thus more stringent than “enabled to”.

It should be noted that the terms “may,” “can,’” and “might” are used to indicate alternatives and optional features and only should be construed as a limitation if specifically included in the claims. The various components, features, steps, or embodiments thereof are all “preferred” whether or not specifically so indicated. Claims not including a specific limitation should not be construed to include that limitation. For example, the term “a” or “an” as used in the claims does not exclude a plurality.

“Conventional” refers to a term or method designating that which is known and commonly understood in the technology to which this disclosure relates.

Unless the context requires otherwise, throughout the specification and claims that follow, the term “comprise” and variations thereof, such as, “comprises” and “comprising” are to be construed in an open, inclusive sense—as in “including, but not limited to.” As used herein, the terms “include” and “comprise” are used synonymously, the terms and variants of which are intended to be construed as non-limiting.

The appended claims are not to be interpreted as including means-plus-function limitations, unless a given claim explicitly evokes the means-plus-function clause of 35 USC § 112 para (f) by using the phrase “means for” followed by a verb in gerund form.

A “method” as disclosed herein refers to one or more steps or actions for achieving the described end. Unless a specific order of steps or actions is required for proper operation of the embodiment, the order and/or use of specific steps and/or actions may be modified without departing from the scope of the present disclosure.

“Processor” refers to a digital device that accepts information in digital form and manipulates it for a specific result based on a sequence of programmed instructions. Processors are used as parts of digital circuits generally including a clock, random access memory and non-volatile memory (containing programming instructions), and may interface with other digital devices or with analog devices through I/O ports, for example.

“Computer” means a virtual or physical computing machine that accepts information in digital or similar form and manipulates it for a specific result based on a sequence of instructions. “Computing machine” is used in a broad sense, and may include logic circuitry having a processor, programmable memory or firmware, random access memory, and generally one or more ports to I/O devices such as a graphical user interface, a pointer, a keypad, a sensor, imaging circuitry, a radio or wired communications link, and so forth. One or more processors may be integrated into the display, sensor and communications modules of an apparatus of an embodiment, and may communicate with other microprocessors or with a network via wireless or wired connections known to those skilled in the art. Processors are generally supported by static (programmable) and dynamic memory, a timing clock or clocks, and digital input and outputs as well as one or more communications protocols. Computers are frequently formed into networks, and networks of computers may be referred to here by the term “computing machine.” In one instance, informal internet networks known in the art as “cloud computing” may be functionally equivalent computing machines, for example.

A “server” refers to a software engine or a computing machine on which that software engine runs, and provides a service or services to a client software program running on the same computer or on other computers distributed over a network. A client software program typically provides a user interface and performs some or all of the processing on data or files received from the server, but the server typically maintains the data and files and processes the data requests. A “client-server model” divides processing between clients and servers, and refers to an architecture of the system that can be co-localized on a single computing machine or can be distributed throughout a network or a cloud.

### DETAILED DESCRIPTION

The elements, features, steps, and advantages of one or more embodiments will be more readily understood upon consideration of the following detailed description, taken in conjunction with the accompanying drawings, in which embodiments, including details, conceptual elements, and current practices, are illustrated by way of example.

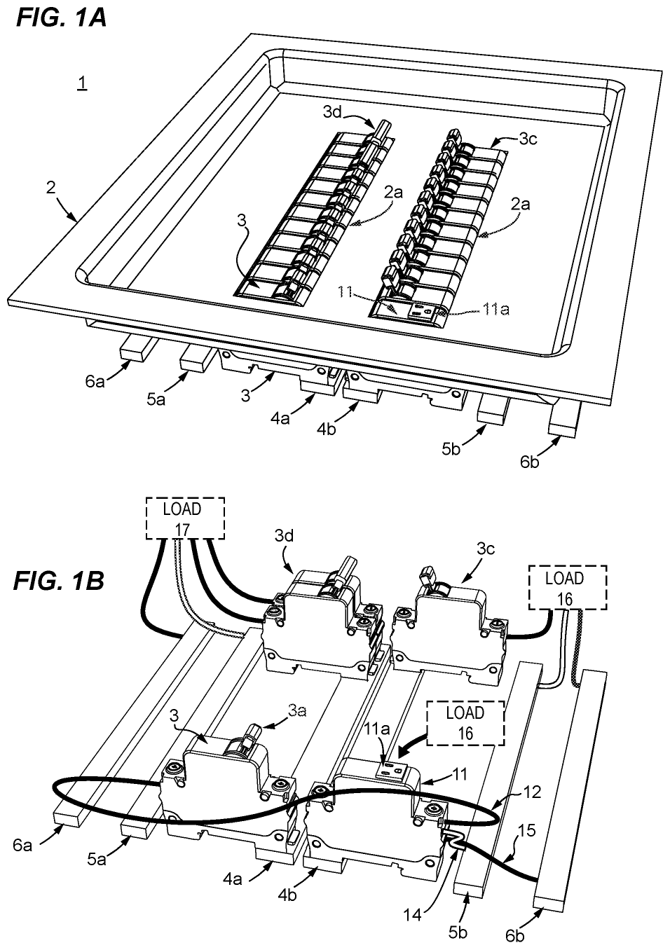

FIG. 1A is view of a breaker panel 1 that includes a dummy breaker device 11 with plug receptacle 11a mounted on the bus bars. Shown here is a female plug receptacle 11a for receiving a pluggable AC extension cord that mounts on the bus bars.

The breaker panel 1 includes a dead front cover panel 2. The cover panel is slotted (cutouts 2a) to expose banks of circuit breakers 3. Breaker 3c includes a conventional 120 VAC single-pole switch. Double-breaker 3d includes a 240 VAC double-pole throw switch. Also shown is dummy breaker device 11 with female plug receptacle 11a. The dummy breaker 11 extends under the front cover panel 2 and seats on the “hot” bus bar without making an electrical connection thereto. Not shown are a front panel door and box with backpanel for supporting the hot bus bars 4a,4b, “neutral” bus bars 5a,5b (or “common”), mains and street wiring. The dual grounds 6a,6b are tied to a single earth ground. The neutral or common is tied to a street common AC lead, and the two hot bus bars 4a,4b are supplied with two phases of AC power conventionally wired from “black” and “red” wire street feeds or equivalent as known in the art. The hot bus bars include interdigitated vertical tabs that fit into “slots” with shoe-connectors in the underside of each circuit breaker body. Other styles of breaker panels are known in the art and the invention is generally applicable with adaptations to be used with breaker panels supplied by various manufacturers, each with a different style. Breaker panels for which this invention is useful include panels make by RS Components, Allied, Schneider, Square D, Siemens, Legrand, Delixi, Eaton, Omron, Leviton, General Electric, Cadence, ABB, Astrodyne, Berthold, Murray and others, while not limited thereto. In the United States, these panels are generally in compliance with accepted standards as tested by Underwriter's Laboratories, Inc. Similar worldwide standards exist. Breaker panels of this kind are intended to be wall mounted, such as in a garage or utility closet against an exterior wall, but may also be mounted in a temporary shelter during construction. The panels are supported by a box-like frame with four walls and a backpanel.

A plug receptacle 11a of this kind is useful for example, in temporarily plugging in a gooseneck lamp, such as when working in a poorly lit garage or closet. The plug receptacle 11a may also be useful in supplying power to cord-operated power tools such as a drill or saw during construction when other circuit outlets are not available. The alternative requires knock-outs on the sides of the breaker panel be removed so that a secondary plug box with plug receptacle can be installed. This is a permanent modification, and may require changes in the structural studs of the supporting framing. A secondary plug box or subpanel may support one or two different plug outlets, but advantageously, dummy plugs of the invention, of which several embodiments are illustrated in the drawings, allow for temporary electrical connections to be made in a “plug and play” mode by which any supported AC configuration, including 120, 240, 480 and various 3-phase combinations are supported by interchangeable modular devices without modification of the breaker panel or external walls.

In a first embodiment, FIG. 1B is a detail view of a dummy breaker 11 with receptacle 11a that seats in breaker panel 1. The female receptacle 11a is configured to receive a pluggable AC extension cord to a load 16. Load 16 may be any plug-in appliance or tool. The dummy breaker 11 is seated on the hot bus bar 4b with a dummy slot, but is not electrically connected to the hot bus bar. It is wired 14 to the neutral bus bar 5b. It is also wired 15 to a ground bus bar 6b. Two ground bus bars are shown (6a,6b) for symmetry. To complete the circuit, the dummy breaker 11 is wired 12 in series to a conventional circuit breaker 3 with single pole throw switch 3a. Current flows from hot bus bar 4a through breaker 3, through hot wire 12 to the plug receptacle 11a, and from there to neutral wire 14 connected (when a load is plugged in) to neutral bus 5b. No extra connection is made from the breaker 3 to the neutral or ground bus bar 5a,6a so that the circuit is fully responsive to the current flowing through the plug-in load.

The plug receptacle 11a is capable of forming a closed circuit when the circuit breaker is closed and a plug-in load is connected between the hot outlet and the neutral outlet of the plug receptacle by the insertion of an external electrical plug into the plug receptacle. In this way, when a live load is plugged into plug receptacle 11a, the load is powered in series with the breaker 3 such that the breaker will trip if there is a circuit overload, short or fault.

For comparison, breaker 3c is shown wired to a 120 VAC load in a conventional manner. Also shown for comparison, double-breaker 3d is shown wired to a 240 VAC load 17 in a conventional manner. Hot bus bars 4a,4b are conventionally inter-tabbed by some manufacturers so that the “black” and “red” phases may be connected to double breaker units 3d when 240 VAC is needed.

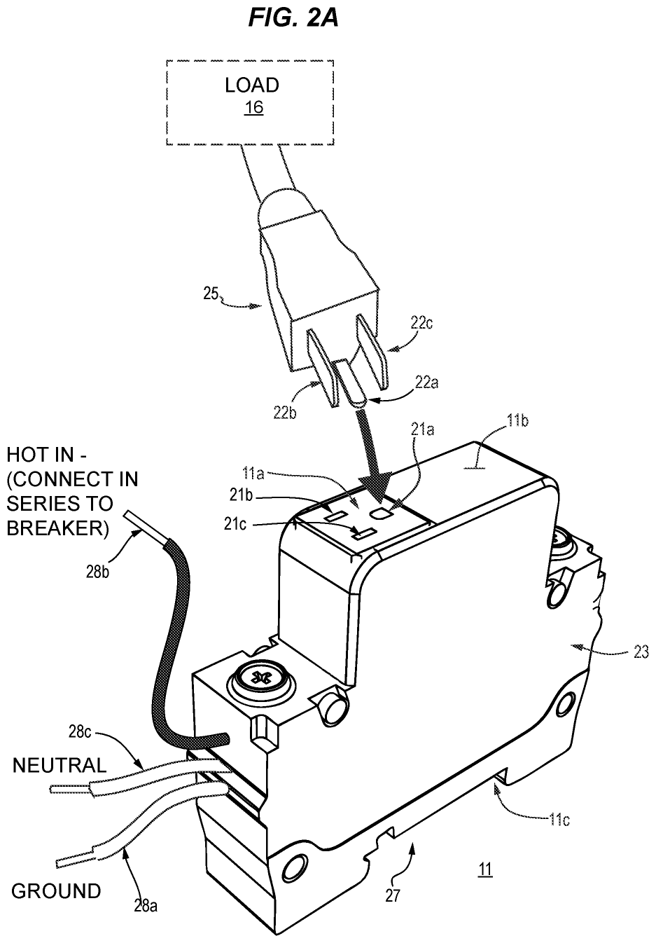

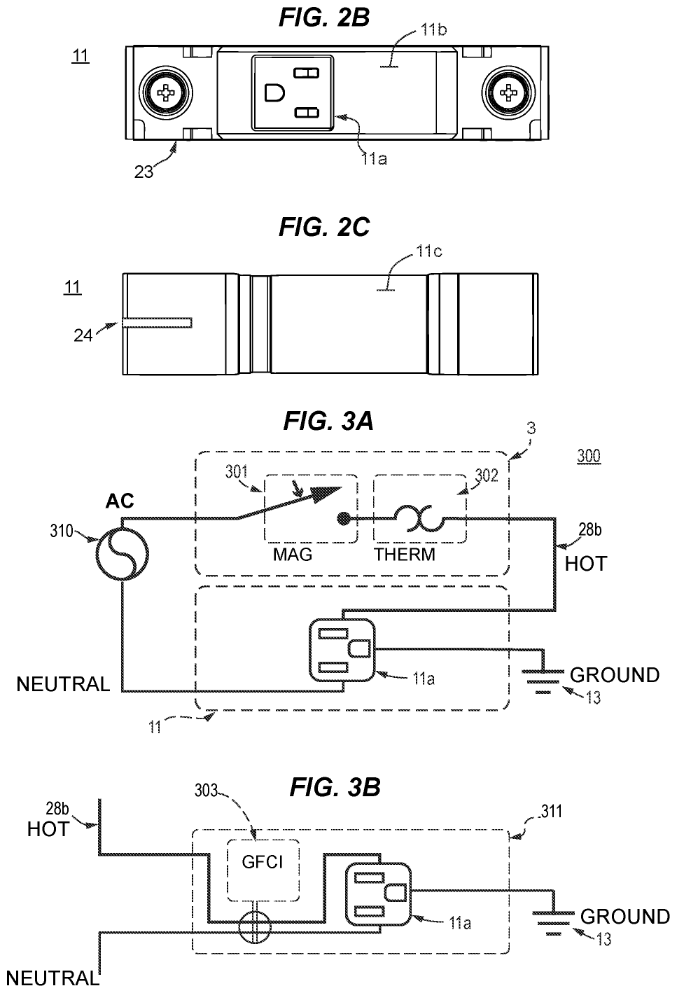

FIG. 2A is a close-up view of a modular dummy breaker device 11 with plug receptacle 11a for receiving an AC plug 25 that connects to load 16. Device 11 includes an upper surface 11b and an underside surface 11c. The underside surface may include a recess 27 for mounting the breaker body on a DIN rail. The modular device 11 is generally rectilinear, and has two lateral sides and two ends. The width of the device between its lateral sides and the length between the two ends is configured to be compatible with a standard slot width of a breaker panel in which it is used. The prongs of AC plug 25 insert or “plug in” to the outlets of the plug receptacle 11a on the upper surface 11b of the device body or “housing” 23. Ground prong 22a of AC plug 25 is aligned with ground receptacle 21a of the plug receptacle 11a to make the connection. Bayonet connections 21b,21c for male tabs 22b,22c are provided. In this view, it can also be seen that the body housing 23 of the dummy breaker device 11 includes three external wire leads (optionally “pigtails”) that connect internally to the outlets 21b,21c,21a of plug receptacle 11a for making external connections to the hot, neutral and ground of the breaker panel. In this embodiment, the external hot lead 28b connects in series to a conventional circuit breaker 3. The external leads 28b,28c and 28a are the HOT, NEUTRAL and GROUND for the plug receptacle. These may be color coded, for example HOT as black, NEUTRAL as white, and GROUND as green. Wires may be braided or solid copper or aluminum, for example, and are sheathed with an insulative layer where exposed.

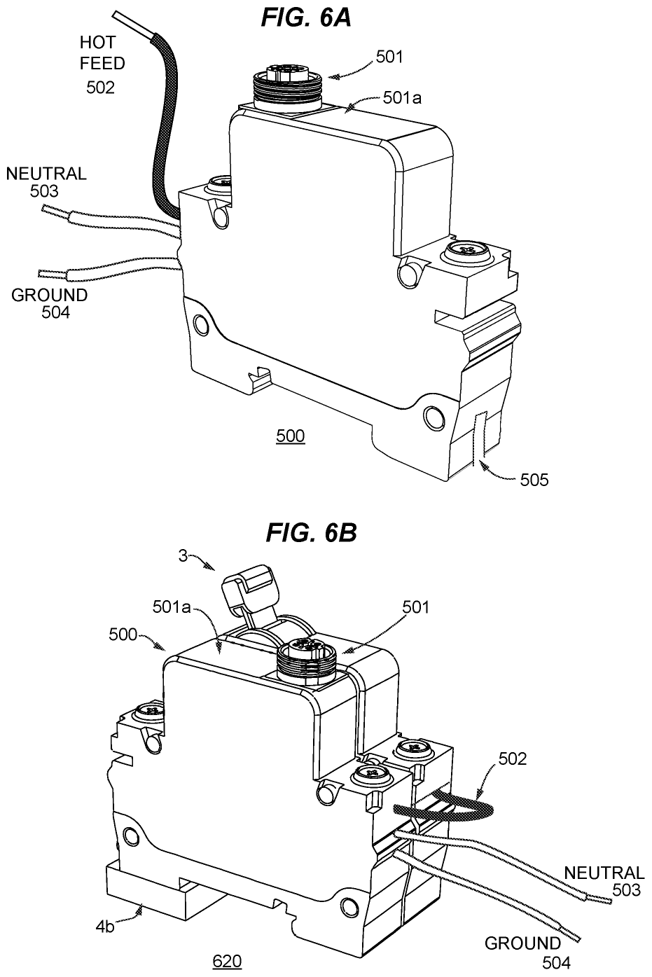

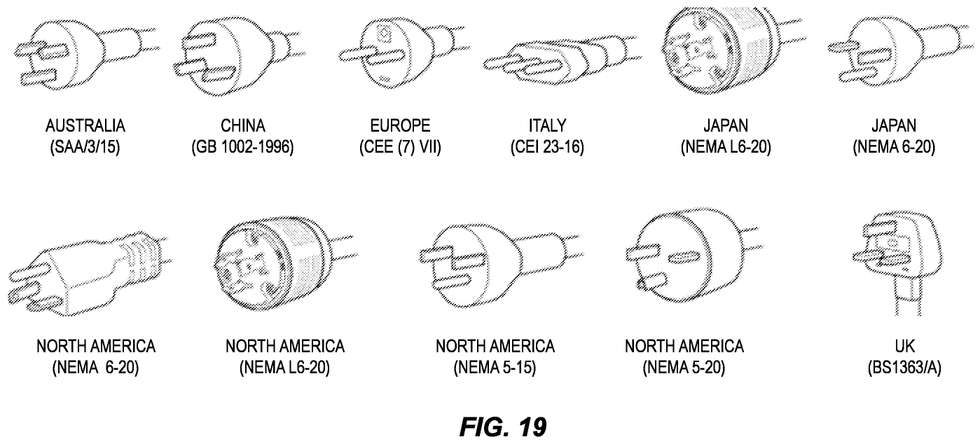

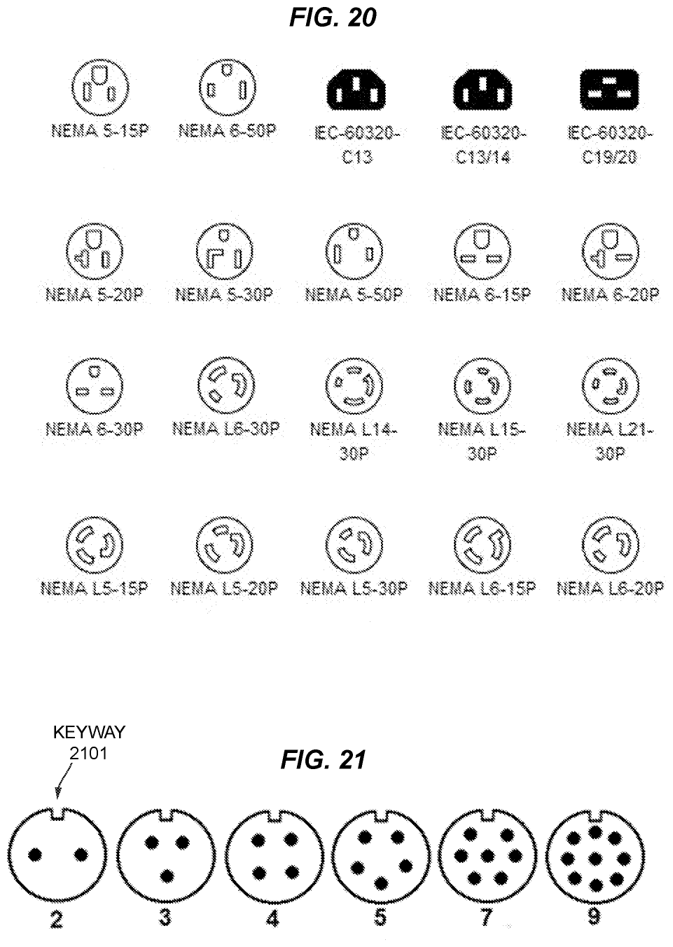

The plug receptacle 11a shown is a NEMA-type plug receptacle conforming to the standards set forth by US National Electrical Manufacturers Association. NEMA plug standards exist for all commonly available power configurations in North America. Such standards include NEMA 5/15, 6-50, 14-30 and so forth, as illustrated more comprehensively in FIG. 20. However, the invention is not limited to plugs of this type, and an alternative embodiment is illustrated in FIG. 6A, for example. The actual shape of the body housing 23 may vary according to the construction of the breaker panel.

FIGS. 2B and 2C are top and bottom isometric views of the dummy breaker device 11 with plug-in receptacle 11a on the upper surface 11b for receiving an AC-plug. The modular body housing 23 is shaped to mimic a conventional circuit breaker body, and includes a dummy slot 24 on the underside surface 11c for seating on a tab of a hot bus bar without making an electrical connection to the hot bus bar. In some instances the hot tab seats in a toe of the body housing 23, but regardless, the dummy breaker device 11 does not allow a live connection to the hot bus bar. FIG. 3A is a schematic 300 showing the series wiring of a dummy breaker device body 11 to a modular circuit breaker body 3 (with magnetic breaker 301 and thermal breaker 302) to an AC circuit. The plug receptacle 11a is embedded in the dummy breaker body with female contacts for receiving the bayonet prongs of a male plug as shown here, but other types of plug receptacles may also be used. Three wire leads are provided for making connections of the HOT, NEUTRAL and GROUND pins of the plug receptacle to external power. In this embodiment, no direct connection is made through the dummy breaker body to the hot bus bar on which the dummy breaker body is mounted. The external leads may be wire leads, for example, of braided copper or aluminum wire core with a strippable insulative cover, for example.

Referring to FIG. 3A, the circuit breaker body 3 is a genuine, fully functional circuit breaker with internal hot shoe for engaging a hot tab of the hot bus bar on an underside toe of the circuit breaker body. Provision is made for wiring a lead 28b to the plug receptacle circuit 11a by which hot AC current is fed to a load. The return from the load is received by the neutral (common) bus bar of the breaker panel. The source AC 310 is typically supplied from a street utility hookup or from a generator.

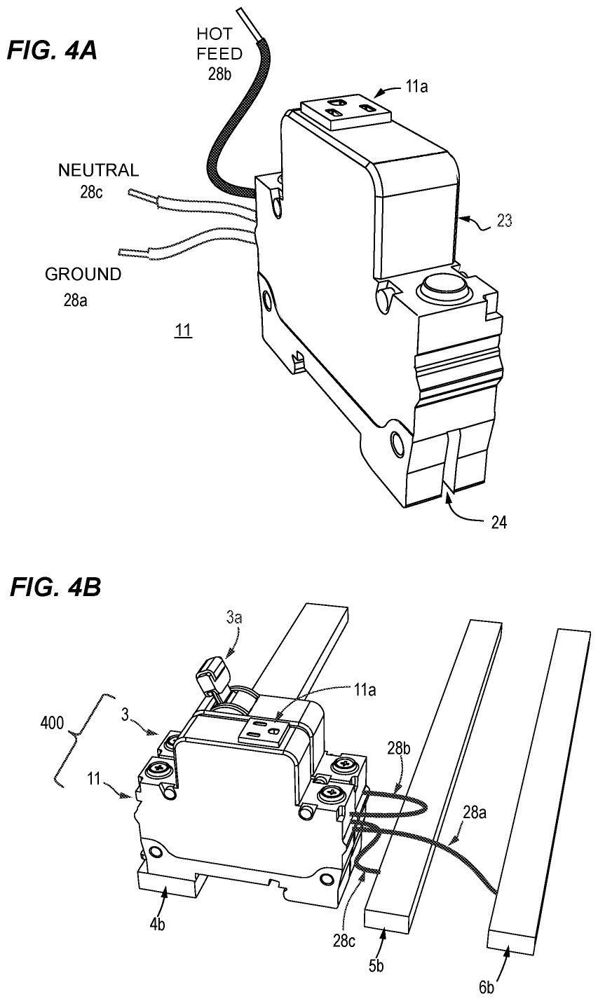

In the embodiment shown in FIG. 3B, the dummy breaker device 311 may include a ground fault circuit interrupt (303, GFCI). As in FIG. 3A, this device 311 is intended to be operated in series with a modular circuit breaker body 3 (which contains a trippable short and thermal fault breaker). The GFCI circuit in device 311 is powered in parallel with the plug receptacle 11a, and inductively compares current in the hot and neutral wires when in use and the circuit is completed by plugging in an appliance or tool to receptacle. The GFCI 303 trips an electromechanical breaker (using a solenoid) in the dummy breaker body 311 if the neutral current return is less than the hot current by 6 mA or more (see UL Standard 943: Standard for Ground Fault Interruptors). Any ground fault creates a differential current between the hot conductor 28b and the neutral conductor 28c (FIG. 4B). Under normal operating conditions, the current flowing in the hot conductor should equal the current in the neutral conductor. Accordingly, GFCIs are typically configured to compare the current in the hot conductor to the return current in the neutral conductor by sensing the differential current between the two conductors. At any instant that the differential current exceeds a predetermined threshold, usually about 6 mA, the GFCI responds by interrupting the circuit. Circuit interruption is typically effected by opening a set of contacts disposed between the source of power and the load. The GFCI may also respond by actuating an alarm of some kind.

The dummy breaker device 311 includes wire leads that extend from the modular body and are for connecting the hot side of the plug receptacle to a neutral terminal of circuit breaker 3 and for connecting the neutral side of the plug receptacle in series to the neutral bus bar 5b (as illustrated in FIG. 4B). A separate lead 13 for grounding the plug receptacle is also provided. Appliances and tools typically are constructed with a chassis ground that is grounded via pin 22a of the plug 25 (FIG. 2A). In this embodiment, the GFCI breaker 303 of device 311 complements the circuit breaker elements 301,302 of body 3 (FIG. 3A) and provides added safety in use. The GFCI is configured to detect ground leakage current and to interrupt current to the plug receptacle 11a if the ground leakage current exceeds a defined limit. The superior surface of device 311 may include a reset switch and a test switch operably connected to the GFCI circuit (not shown). The superior surface of device 311 may include one or more indicator lamps configured to display a status of the circuit when a plug is inserted in the plug receptacle. The underside surface may be configured to be mounted on a DIN rail inside the breaker panel, for example.

Body units 3,11 and 311 have a modular form factor and are compatible with a conventional breaker panel and with the hot, neutral and ground connectors of the breaker panel. The two body units (the circuit breaker 3 and either of modular device 11 or 311) can be placed cis- or trans- on the bus bars (i.e., crosswise on the bus bars or stacked side-by-side). Generally the ground connection 13 is made directly from the plug receptacle 11a to the ground strap of the breaker panel.

FIG. 4A is a perspective view of a dummy breaker device 11 with plug receptacle 11a and wiring. Dummy slot 24 is made in body housing 23 so that the unit can insert directly onto the hot bus bar in the breaker panel, but has no active electrical connection. In FIG. 4B the dummy breaker 11 and true breaker 3 are seated side-by-side and are wired in series to a breaker box and have the same general modular form factor. Circuit breaker 3 includes single throw pole 3a. Wire lead 28b connects the dummy breaker plug to the hot bus bar through circuit breaker 3. Direct connections are made from the dummy breaker 11 to the neutral bus bar 5b and ground 6b to complete the circuit when a plug and live load are inserted into the plug receptacle 11a. Wire 401 connects the hot plug pin of the plug receptacle to the hot bus bar through the circuit breaker body 3.

When side-by-side, the lateral walls of the two modular body units 3,11 are in close contact or are stacked. In another embodiment, the dummy breaker 11 and circuit breaker 3 can be provided as a paired unit 400 having two halves for convenience and may be pre-wired for simplified hookup. The two component parts of circuit breaker/plug receptacle unit 400 may share a single ground strap (shown here as a ground bar 6b).

Unit 400 may be supplied with ground fault interrupt (GFCI) as described in FIG. 3B, if desired, or by providing an equivalent GFCI circuit within the circuit breaker body 3. While provision of ground lead 28a is not required for operation of a GFCI interrupt, the ground lead serves the protective function of directing current leakage through the plug receptacle and to a ground strap in the panel rather than through another conductor. The white wire or “pigtail” on a GFCI plug receptacle serves two functions. It completes the connection to the panel neutral bar for the neutral load conductor and also completes the power supply circuit for the electronics of the GFCI circuit interrupt. The white pigtail wire must still be connected to the neutral bar in the load center or panel board in order for the electronic ground-fault protection circuit to function.

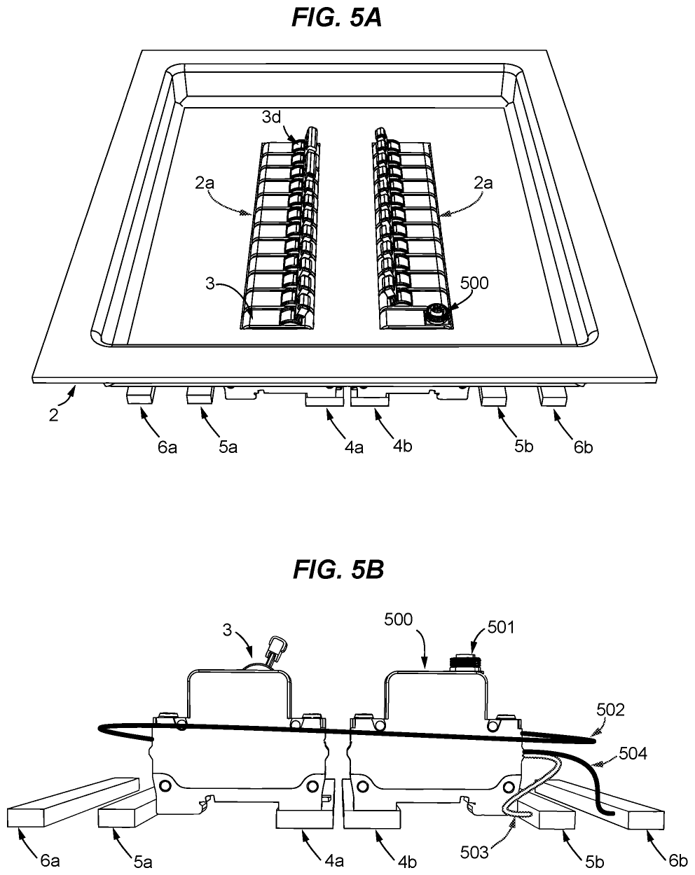

FIG. 5A is a view of a second breaker panel that includes a dummy breaker body 500 with AC plug receptacle 501 (FIG. 5B), shown here as a female plug receptacle 501 for receiving a pluggable aviation-type extension cord in series with a circuit breaker. Arrayed in cutouts 2a in the front panel 2 are example circuit breakers 3,3d. A conventional 120 VAC breaker 3 and a 240 VAC double-throw breaker 3d are illustrated. Also illustrated figuratively are hot bus bars 4a,4b, neutral bus bars 5a,5b and paired ground bus bars 6a,6b. Dummy breaker 500 includes an aviation-type circular plug receptacle 501 (FIG. 5B) configured to receive a mating plug for making an electrical connection.

FIG. 5B shows a first embodiment of a breaker body/aviation plug receptacle 500, as is useful with a conventional circuit breaker 3 in series. The plug receptacle 501 is surface-mounted in the dummy breaker body 500 and includes a dummy slot without hot shoe for electrically connecting to the hot bus bar 4b on which the body rests. Instead the dummy slot 505 (FIG. 6A) acts to support the dummy breaker body on the bus bar, but the hot feed is wired from an adjoining circuit breaker 3 via wire lead 50. The hot lead 502 from the dummy breaker body 500 is wired to a genuine circuit breaker 3, which inserts onto a tab of hot bus bar 4a (or 4b, depending on whether the orientation is a cis- or trans-mounted breaker). The dummy breaker body includes a wire 503 for connecting to the neutral (common) bus bar 5b and a ground wire 504 for connecting to ground strap 6b. In this way, when a live load is plugged into plug receptacle 501, the load is powered in series with the breaker 3 such that the breaker will trip if there is a circuit overload or fault.

FIG. 6A is a detail view of a dummy breaker device 500 with aviation plug receptacle 501 on the upper surface 501a fitted for series wiring to a circuit breaker. The aviation plug receptacle 501 is circular and is threaded to receive a male plug with threaded outer sleeve and 4-pin prongs. The dummy breaker body includes a dummy slot 505 that does not have a hot shoe and seats on the hot bus bar but does not electrically connect to the hot bus bar.

FIG. 6B shows a dummy aviation plug receptacle 500 in series with a circuit breaker 3 that is cis-mounted on an adjoining hot bus bar 4b tab. By placing the circuit breaker in a side-by-side position next to the dummy breaker with plug receptacle, hot wire 502 in series is trimmed to be a shorter connection than shown in FIG. 5B. In one embodiment, the dummy breaker and the circuit breaker are supplied separately and are subject to different standards. The two parts may be separable and wired in series as a head-to-head pair as shown in FIG. 5B or as a side-by-side pair shown in FIG. 6B. Conventional circuit breaker 3 is used without modification by wiring it to the adjoining dummy breaker body 500 (as shown, wire 502) instead of to a wire harness directly from a load.

The plug receptacle 501 is capable of forming a closed circuit when the circuit breaker is closed and a load is connected between the hot outlet and the neutral outlet of the plug receptacle by the insertion of an external electrical plug into the plug receptacle.

The plug receptacle 501 is live when the single-pole throw breaker bar of circuit breaker 3 is in the live position, and if the breaker is tripped, the plug receptacle is disabled. The breaker can include a magnetic interrupt to trip if there is a circuit short, a thermal interrupt to prevent overheating, and may also include a ground fault interrupt. The body of the dummy breaker 500 may also include a GFCI interrupt, and solid state indicators of functionality, such as an LED or LEDs to show that the plug is live and correctly wired, for example.

In another embodiment, the dummy breaker and circuit breaker may be supplied as a single unit 620 and pre-wired in series for convenience. Wire 502 may be looped as shown in the paired body 620, for example. External leads 503,504 to neutral and ground connections are also supplied. The paired body unit 620 will include two slots, one a dummy slot as part of the dummy breaker body 500, and the other a slot with hot shoe as part of the circuit breaker assembly 3. The hot shoe of circuit breaker 3 of combination breaker/plug unit 620 is engaged on a hot tab of hot bus bar 4b as shown. The body unit 620 may also include a GFCI interrupt and solid state indicators of functionality, such as an LED or LEDs (now shown, see FIG. 30) to show that the plug is live and correctly wired, for example.

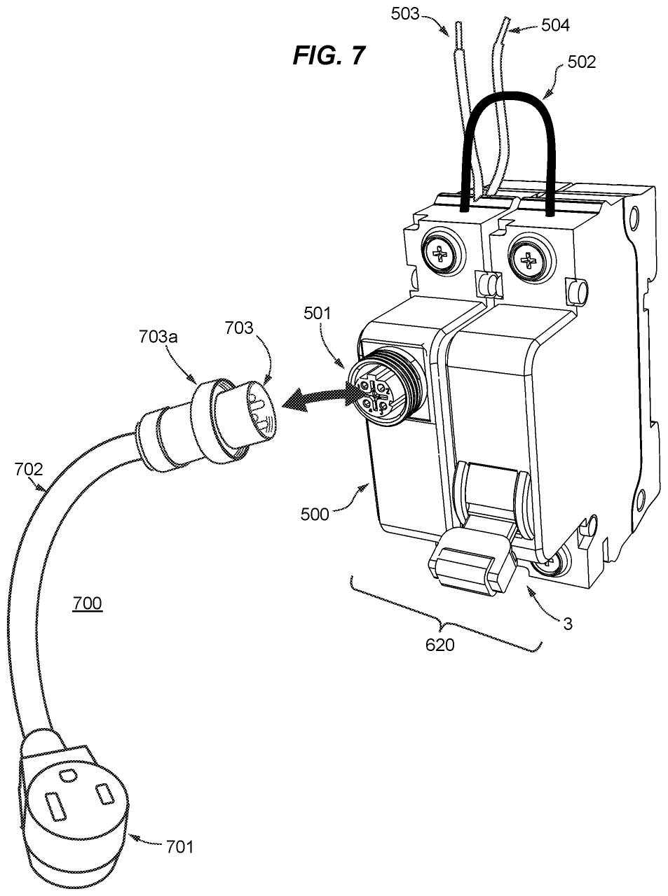

FIG. 7 is a view of an adaptor 700 with AC plug 701 and a male aviation-type fitting 703 that plugs into an aviation-type plug receptacle 501 of a dummy breaker 500 wired in series with an AC circuit breaker 3. In this instance, the dummy breaker and circuit breaker are paired as a functional unit 620 and insert onto the hot breaker bar in combination. An internal lead (not shown) may connect the plug receptacle 501 to the hot shoe of the breaker, or the lead may be an external wire loop 602 (as shown) so that the two paired body units 3,500 remain functionally separate in their internal workings.

The short adaptor 700 may be one of a set for use with the breaker/plug unit 620. The adaptor includes a plug head 701 for receiving a power cord from an appliance or load, and a plug 703 with threaded sleeve 703a for engaging the plug receptacle 501 of the dummy breaker body 500. Alternate adaptors may include alternate plug heads 701. The adaptors and plug receptacles may include keyways to ensure compatibility. Each breaker/plug unit 620 may be specified according to the kind of electrical connections it can make. Swapping out different dummy breaker devices 500 allows one circuit breaker 3 to be used to protect a variety of plug connections.

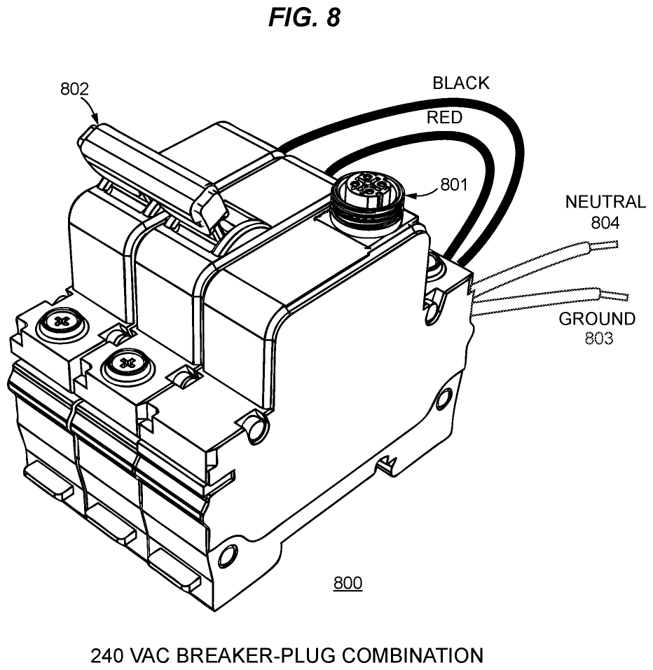

FIG. 8 is a view of a 240 VAC breaker/plug assembly 800 with two circuit breakers and double throw pole 802 and series wiring to an aviation-type receptacle 801. Wiring for a dedicated ground 803 is also provided. Neutral wire 804 is useful in establishing a GFCI circuit. The three breaker/plug body modules are configured to insert onto hot tabs of the hot bus bar, with the exception that the dummy plug body is not directly wired, but instead is hot-wired via the BLACK and RED leads shown here and a double pole throw switch 802 is installed. This ensures that the circuit breaker elements function exactly as conventional circuit breaker elements.

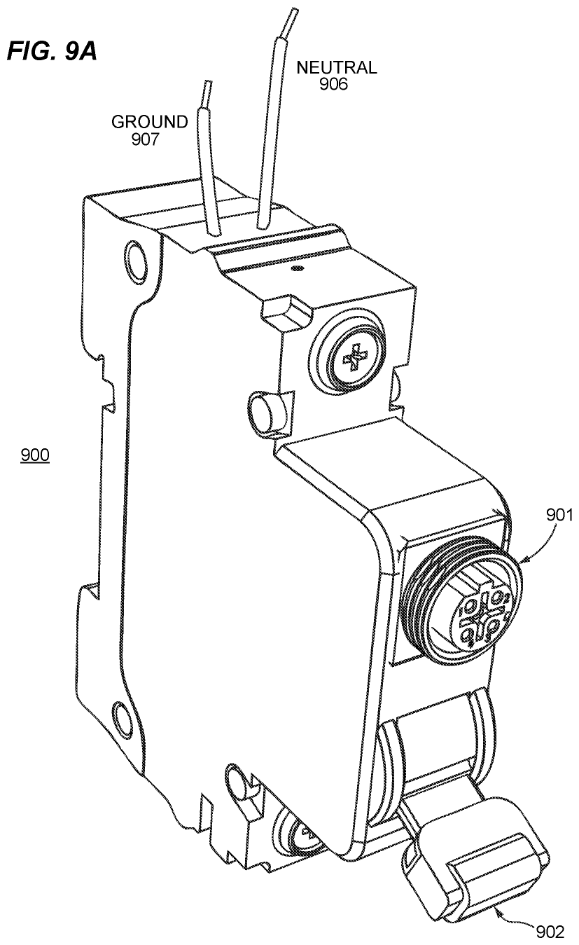

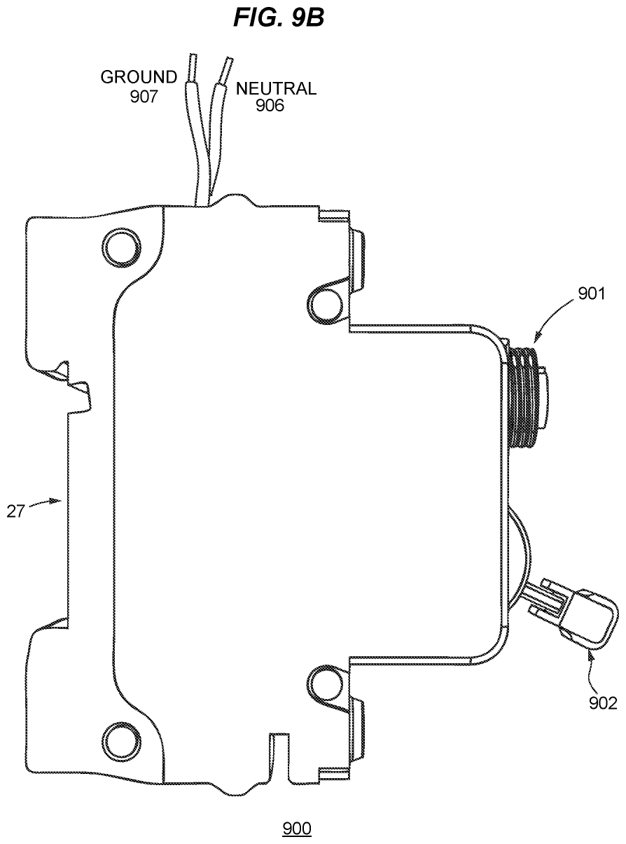

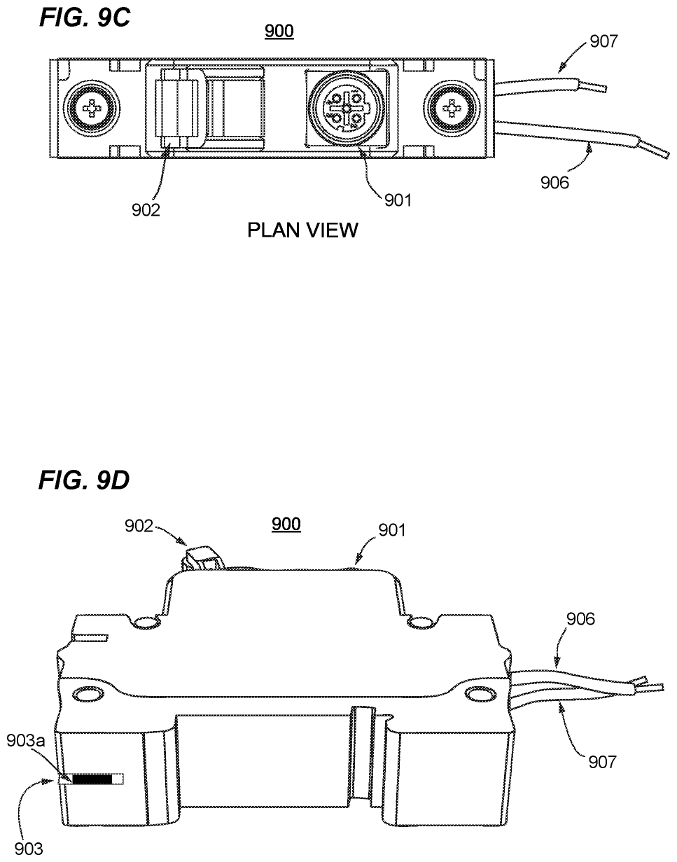

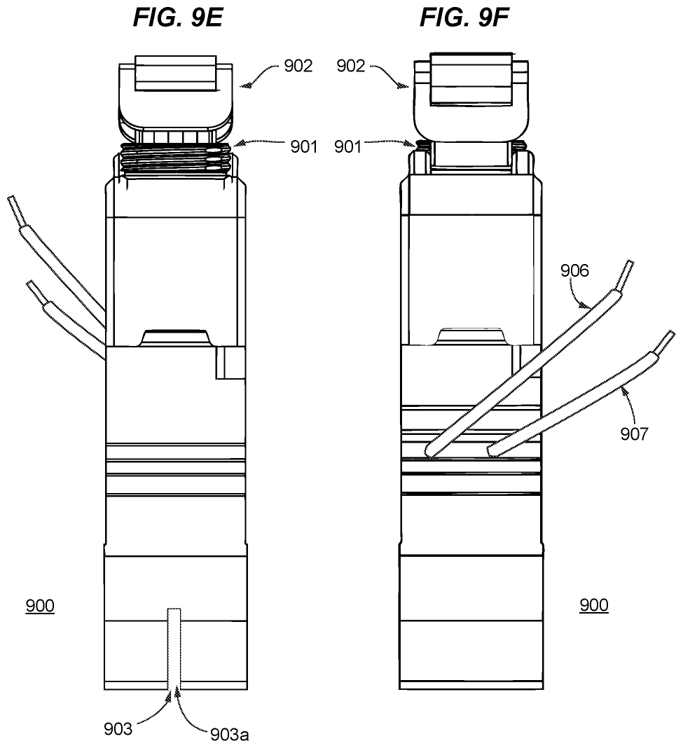

To illustrate another embodiment, FIGS. 9A, 9B, 9C, 9D, 9E and 9F are isometric and perspective views of a circuit breaker/plug body 900 with plug receptacle 901 in a single-width body that is insertable in a single slot of a breaker panel. In this embodiment, the breaker and plug elements are incorporated as a combination in a single body unit having the modular dimensions of a circuit breaker body. The slotted body underside 27 is configured for installation on a DIN rail of a breaker panel. Wiring is supplied for making neutral and ground connections to the neutral bus bar and ground strap of the breaker panel. A hot shoe (903a, FIG. 9D) is provided in the base of the breaker body for connecting to the hot bus bar. The perspective view of FIG. 9A shows a single throw circuit breaker pole 902 specified for 120 VAC. The circular aviation-type plug receptacle 901 is intended for use with an adaptor 700 such as shown in FIG. 7 that can come in various configurations. FIGS. 9B and 9C are elevation and plan views of the combination breaker/plug 900. While not shown, the top face 900b of the breaker/plug combination may include an LED or LEDs that act as indicators of circuit status, for example a fault indicator or a live power indicator, if desired. Optionally, a surface-mounted LED can assist in providing illumination of the plug-receptacle so as to assist when inserting a plug under poor lighting conditions.

FIG. 9D is an underside perspective view of the combination breaker/plug 900 showing the underside surface 900c of the device body, and illustrates a front-facing slot 903 that contains a hot shoe 903a for making a connection to a hot tab of a hot bus bar 4a or 4b of the breaker panel. Current flows from the hot shoe 903a, through the breaker with single-throw pole 902, and to the plug receptacle 901 (FIGS. 9C, 9B), such that when a load is connected, the circuit is completed through the external neutral lead 906 to neutral bus bar 5a or 5b of the breaker panel. These plugs also typically come with a ground lead 907 for external connection to electrical ground and the units may be GFCI-certified if desired. The switch pole 902 may be tripped manually to cut power to the plug receptacle, or may be tripped automatically if there is a circuit overload or fault.

FIGS. 9E and 9F are front and back end views of the combination breaker/plug 900 with plug receptacle 901, single-throw pole 902, and illustrate the hot shoe 903a in a slot 903 on the front 900d of the body and external ground and neutral wires 906,907 on the back end 900e of the body. Unit 900 may be supplied with ground fault interrupt (GFCI) if desired. While provision of a ground lead 907 is not strictly required for operation of a GFCI interrupt, the ground lead serves to direct current leakage through the plug receptacle and to a ground strap in the panel. A ground fault creates a differential current between the hot conductor at 903a and the neutral conductor 906. Under normal operating conditions, the current flowing in the hot conductor should equal the current in the neutral conductor. Accordingly, GFCIs are typically configured to compare the current in the hot conductor to the return current in the neutral conductor by sensing the differential current between the two conductors. At any instant that the differential current exceeds a predetermined threshold, usually about 6 mA, the GFCI responds by interrupting the circuit. Circuit interruption is typically effected by opening a set of contacts disposed between the source of power and the load. The GFCI may also respond by actuating an alarm of some kind.

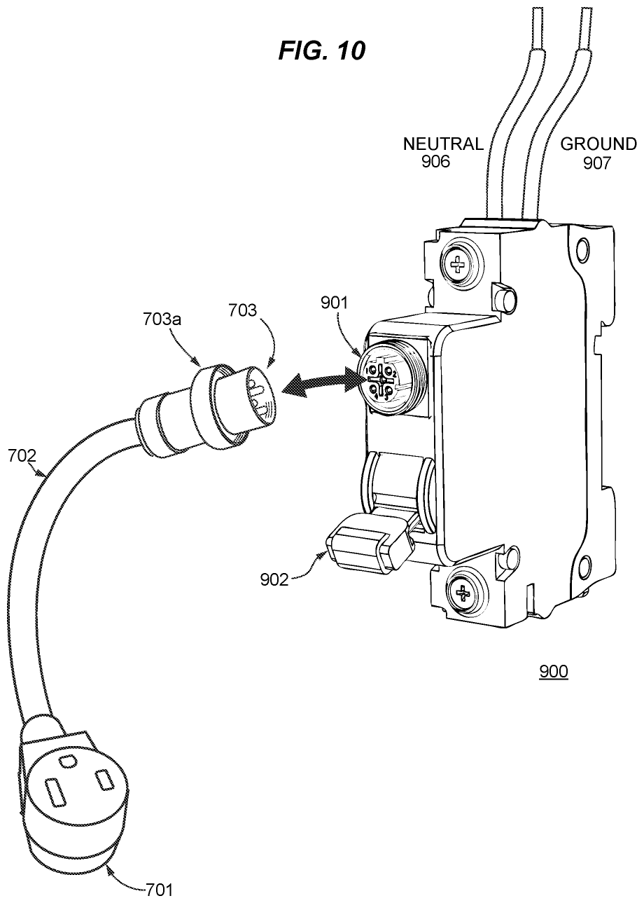

FIG. 10 shows a circuit breaker/plug combination body 900 in a context of use; here with an adaptor cord 702 that adapts a 4-pin male plug 901 to a female NEMA 5-15 receptacle 701. The breaker/plug combination includes a single-throw switch 902 that is tripped if there is a circuit overload or fault. The body 900 includes a hot shoe that seats on a hot tab of a hot bus bar and two external wires, one to the neutral bus bar and one to ground. The plug receptacle 901 is fully grounded.

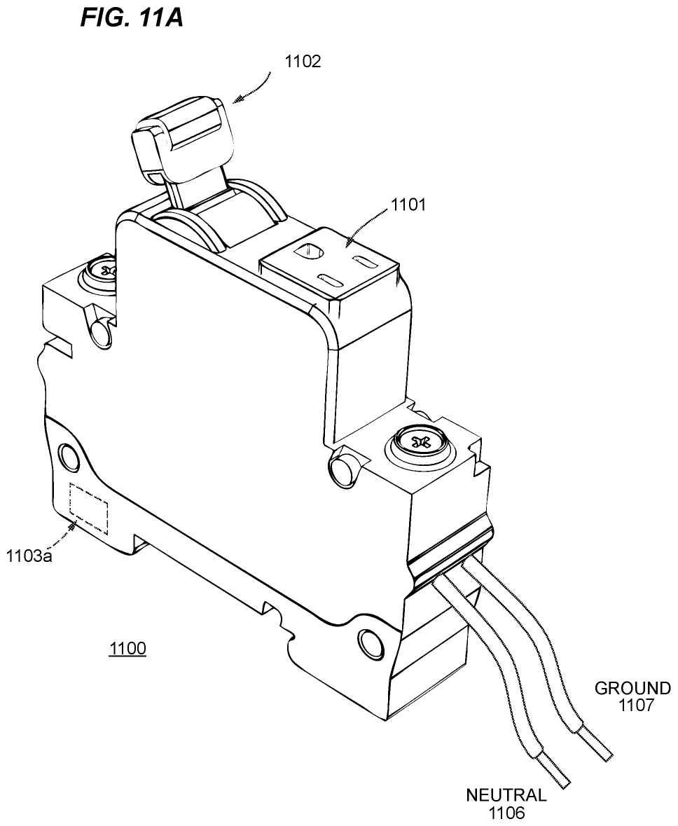

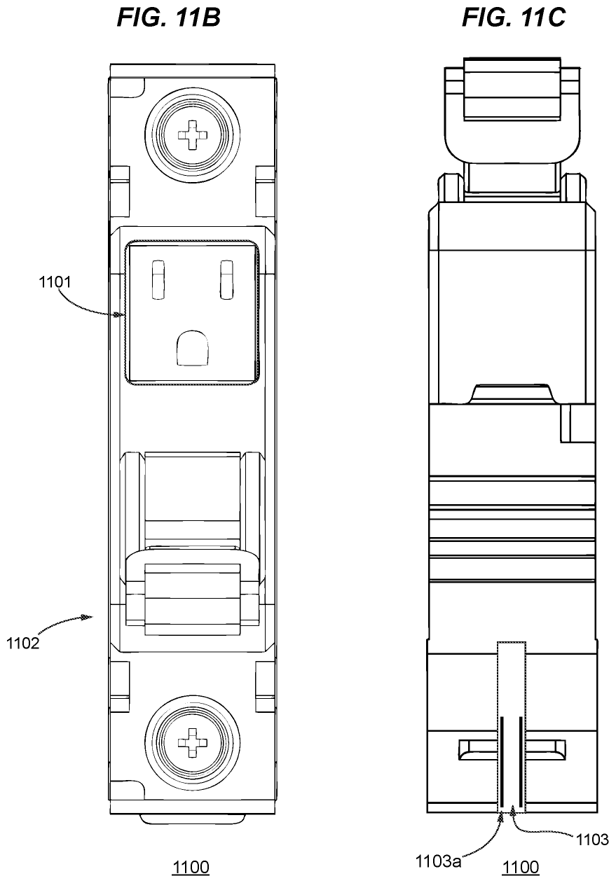

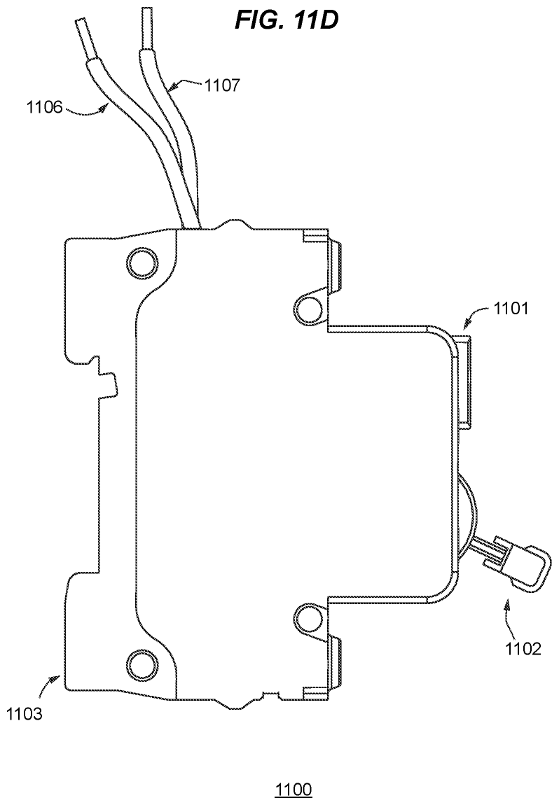

FIGS. 11A, 11B, 11C, and 11D are isometric and perspective views of a circuit breaker/plug body 1100 with 120 VAC NEMA 15-5 plug receptacle 1101 and single throw pole 1102. This embodiment is analogous to that of FIG. 9A, but incorporates the NEMA-type plug receptacle. The body may be configured to support a GFCI receptacle standard if desired. Two external wires are supplied 1106,1107, one to the neutral bus bar and one to ground. The hot shoe 1103a (in slot 1103) that seats on the hot bus bar is connected internally to the plug receptacle 1101. FIGS. 11B and 11C show plan and end views respectively. FIG. 11D is a side elevation view showing the external wires for neutral 1106 and ground 1107 connections.

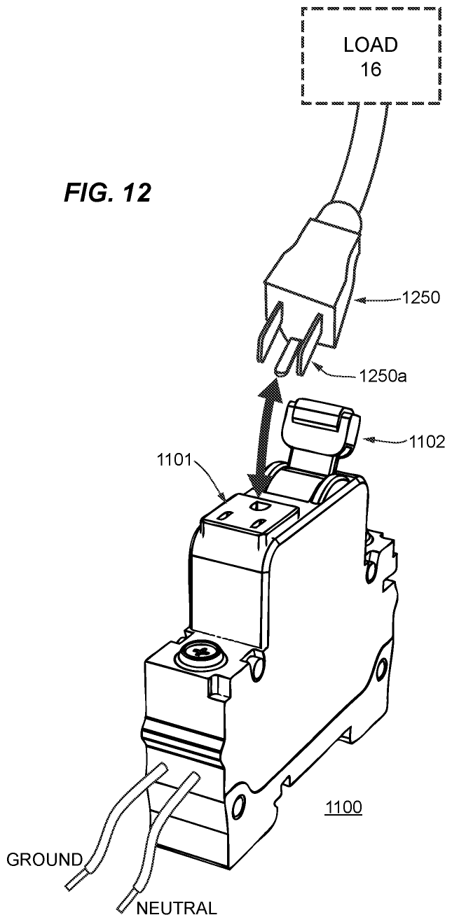

FIG. 12 illustrates the combination circuit breaker/plug body 1100 in a context of use; here with a standard NEMA-Type plug 1250 with bayonet prongs 1250a and cord that inserts into the female NEMA 5-15 receptacle 1101 on the combination body. For reference, the cord is indicated to be connected to a load 16. The combination circuit breaker/plug body 1100 enables use of a live breaker panel for temporary attachments of tools, for example, while not limited thereto, without the need to have a wall-mounted hard-wired receptacle within reach of the tool cord. The rigid plug 1250, when mounted in plug receptacle 1101, does not interfere with operation of the single-throw pole 1102. As installed, when not in use, the combination circuit breaker/plug body 1100 does not interfere with closure of the breaker panel front panel door.

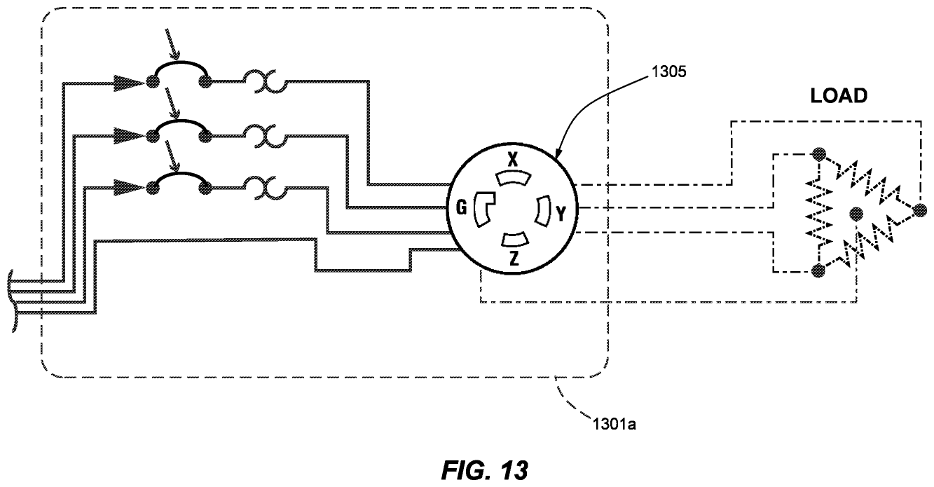

FIG. 13 is a schematic of a circuit breaker/plug receptacle combination 1301a configured for 3-phase applications. Each of the phases is provided with a separate fuse. A 3-phase load is shown for reference. The breaker plug assembly 1301a, shown here schematically, is wired with a neutral return line that includes a ground. As shown here, the plug receptacle is a NEMA L21-30P receptacle 1305. Three-phase power has the advantage of supplying greater torque to motors, for example. This device is configured to be mounted directly within a breaker panel with exposed plug surface.

In another embodiment, the combination circuit breaker/plug body includes a single NEMA L16-30R for receiving a mating NEMA L16-30P plug (not shown). The device is suitable for temporary use and may be removably clipped into a breaker panel by a homeowner or tradesman without the need to install wall-mounted plug boxes on the breaker panel. In some instances the poles of the circuit breaker will be engaged on an existing 240 VAC station in the breaker panel and will combine a third 120 VAC pole. All the wiring may be powered by a single feed from an offsite mains that supplies power from an electric grid or from a generator, for example.

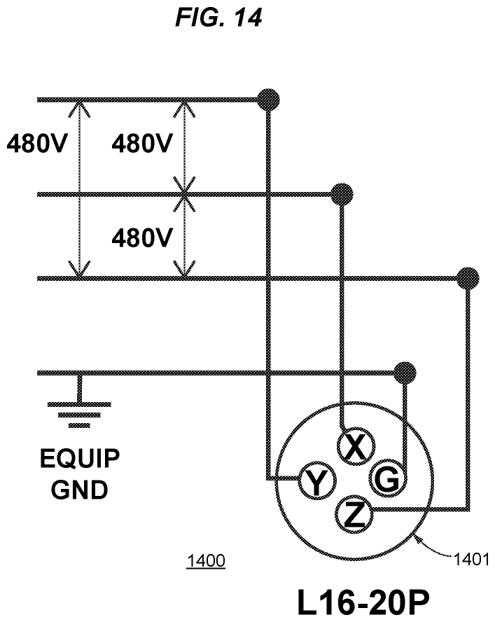

FIG. 14 is a schematic showing a 480 VAC circuit breaker plug receptacle 1400 and wiring. Two 3-phase power schema are commonly available in the United States: 240 VAC and 480 VAC. 480 VAC is more commonly found in industrial and commercial settings. In this instance, the body of the breaker/plug combination includes a NEMA 16-20P receptacle 1401 of traditional wiring, but a threaded aviation circular connector may also be used. A system of keyways may be used to identify compatible plugs and to ensure that pin wiring is correctly mated across the connector. While not bound by theory, the circuit breaker/plug devices may be adapted for multiphase AC configurations at higher voltage drops without departure from the spirit of the inventive concepts.

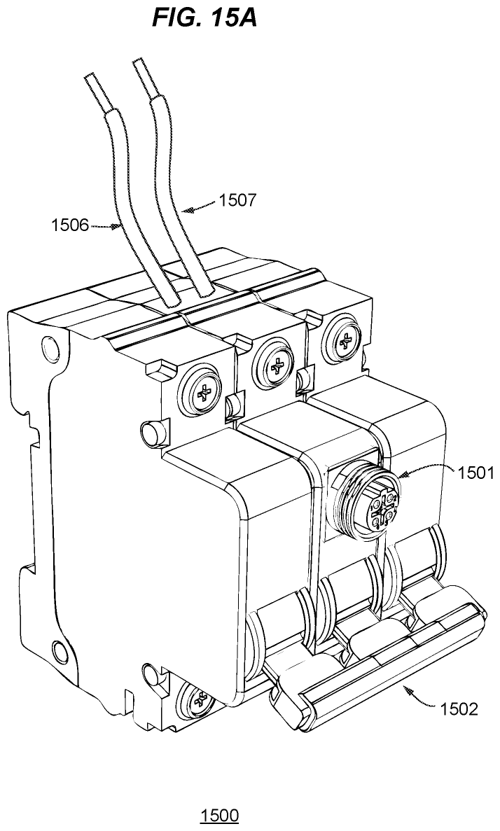

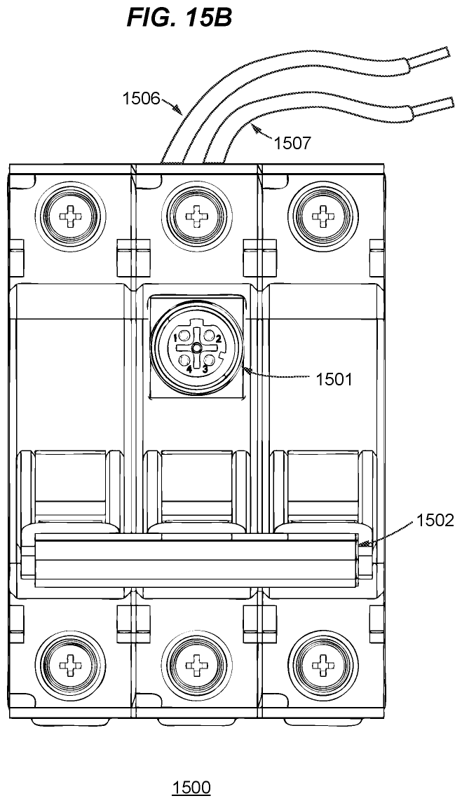

FIG. 15A is a perspective view of a 3-phase circuit breaker plug assembly 1500 with aviation circular connector 1501 and combined triple-pole throw switch 1502. The assembly includes neutral 1506 and ground leads 1507, as indicated to attach directly to the combination breaker/plug body units, which insert onto the hot bus bar with shoes at the opposite end of the body. FIG. 15B shows the 3-phase combination breaker/plug assembly 1500 in plan view. The body units are contacted at lateral walls and are fitted with a common throw bar. Each breaker engages one of the three-phase hot feeds.

FIG. 16 shows triple circuit breaker/plug combination 1500 with aviation-type circular plug receptacle 1501 in a context of use with a plug cord adaptor 1552. The breaker housing is slotted or otherwise toed so as to mount directly and engage the hot bus bar(s) of a breaker panel. Voltage on each of the hot bus bars is returned on a single neutral or common and is controlled with a single combined throw switch 1502. Neutral and ground leads are wired to the neutral and ground bus bars of the breaker panel. In this instance, the receptacle is configured with an aviation circular connector 1501 rather than a NEMA receptacle. The 4-pin circular connector 1501 is configured to receive (as an adaptor) a mating aviation connector 1551 with male pins and a safety threaded sleeve 1551a which can be waterproofed to the IP67 or IP68 standard. A gasket may be used inside the connector and inside surfaces of the throw switches. A system of keyways may be used to identify compatible plugs and to ensure that pin wiring is correctly mated across the connector.

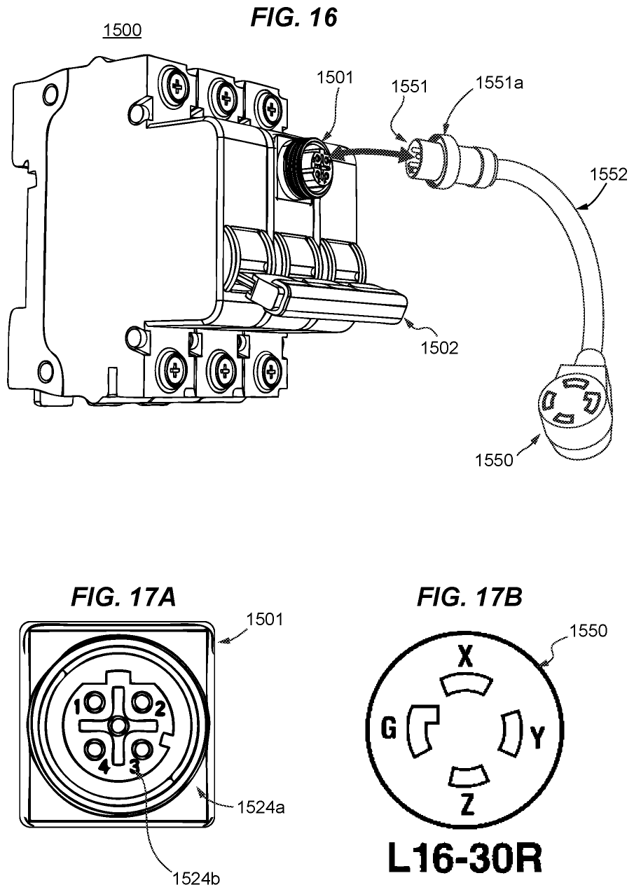

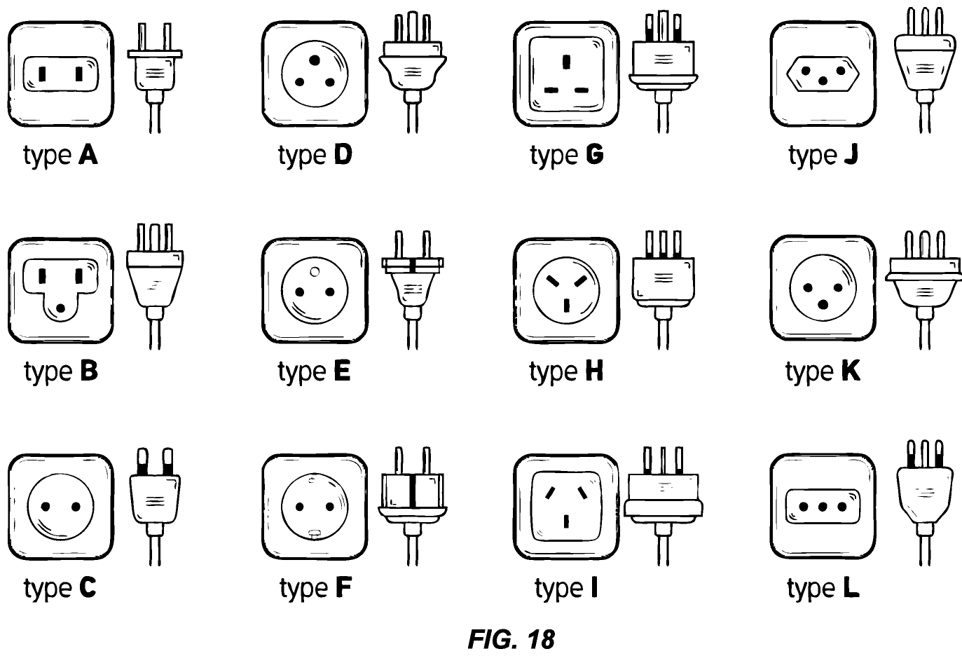

The plug receptacle 1501 is shown in plan view in FIG. 17A. Aviation circular connector 1501 includes numbered pin receptacles. Pin 4 for example may be a common and pins 1, 2 and 3 may be phases for 3-phase power. The face of the plug receptacle is marked 1520a and pin 3 is marked 1524b for reference.

The opposite end of the adaptor 1552 shown in FIG. 16 is drawn in plan view in FIG. 17B. This is a NEMA L16-30R plug 1550 with ground or common G and phases X, Y, and Z for each of three phases of a 3-phase power supply. The short cord length 1552 may instead be directly wired to an appliance or load in need of electrical power.

In one embodiment, the single receptacle joins three separately fused AC phases to a common return. The breaker assembly also may include solid state components for monitoring operation, such as a green LED when the circuit is correctly installed and all phases are operating correctly and a blue LED when the circuit is live. Operating temperature and load may also be monitored.

As suggested by FIG. 18, the circuit breaker plug assemblies of the invention may be modified to include any of a variety of plug receptacles so as to be compatible with any of a variety of international plug standards. Typically the circuit breaker plug is fitted with a female receptacle so that hot pins are not exposed. It can be seen that the breaker plug assembly is universal device for converting a circuit breaker into a circuit breaker plug for ready access to power directly at a breaker panel. While several examples have been drawn as illustrations, the concept is not limited to any particular plug and receptacle configuration or country of use and may be adapted to other styles of breaker panels.

Examples of various male plugs according to country of use are shown in FIG. 19. These are exemplary and may not include all representative power plugs that are adaptable to the inventive structures and hence the invention is not limited thereto.

FIG. 20 is a graphical representation of various female connectors, here showing receptacles according to the NEMA standard used commonly in the United States. According to various embodiments, these are a representative of those plugs adaptable to the inventive structures, but not fully inclusive collection of plug types that can be adapted to the practice of the invention.

FIG. 21 is a view of “single-keyway” 2101 circular aviation connectors; the connectors have two to nine pin receptacles as commonly known and used. The circuit breaker plug bodies of the invention may be adapted to any of the pin configurations according to various embodiments. A keyway configuration may be assigned to any of the pin layouts so that a correct connection is always made. Embodiments having four or five pins are of interest in that the receptacle and plug may have four or five pins configured for carrying up to three hot phases, a neutral and/or a ground. Alternatively, the connector may be an aviation type receptacle of the “GX16 reverse class” having exterior threads in which the mating plug is a compatible male plug having 2 to 10 pins and a threaded sleeve with internal threads.

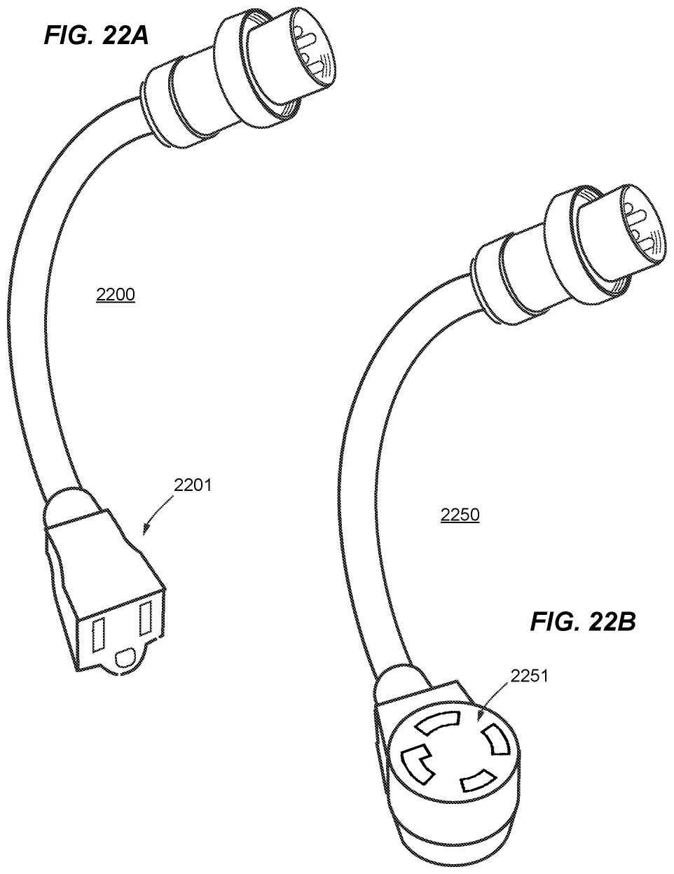

FIGS. 22A and 22B are views of two adaptor cords 2200,2250 having each a short cord with two distinct ends. In this representative example, embodiments of various adaptors are shown having each a 4-pin aviation male “reverse” connector on a first end and either a standard NEMA 120 VAC plug 2201 (shown here as a female plug) or a NEMA 240 VAC plug 2251 on a second end. One or more adaptor cords may be supplied with a mating universal circuit breaker plug assembly of the invention as a kit.

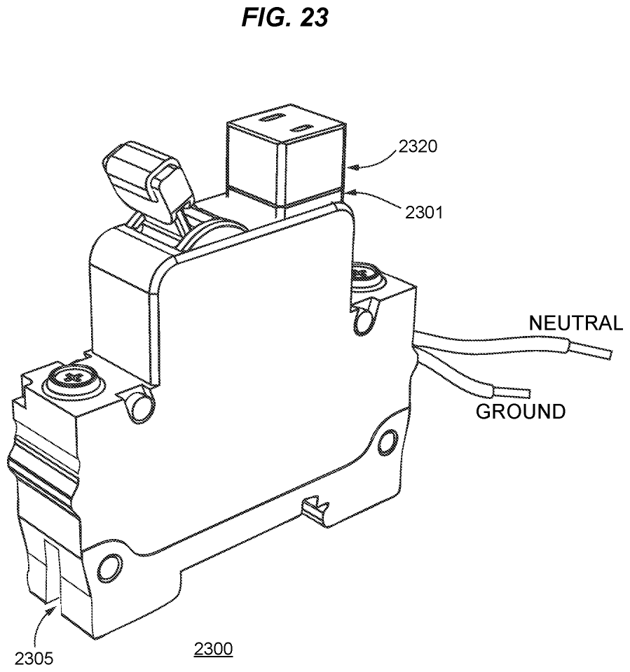

FIG. 23 is a view of a combination circuit breaker/plug device 2300 and a “plug-in” adaptor 2320, shown here as useful to convert a 3-prong plug receptacle 2301 with ground to a simple two-prong receptacle that is commonly used for household 15 Amp appliances. A variety of plug-in adaptors may be provided. Although this can defeats the ground fault protection, the “plug-in” adaptor 2320 may be fitted with a ground lug and external wire (not shown) as known in the art that is recommended to be connected to a ground strap for safe use. While not ideal, many small appliances are not supplied with 3-prong plugs; hence the need for a two-prong adaptor. By adding a GFCI breaker to the device 2300, ground fault protection is extended to plug-in appliances having two-pin male plugs and no chassis ground connection.

### Example I: GFCI Combination Device

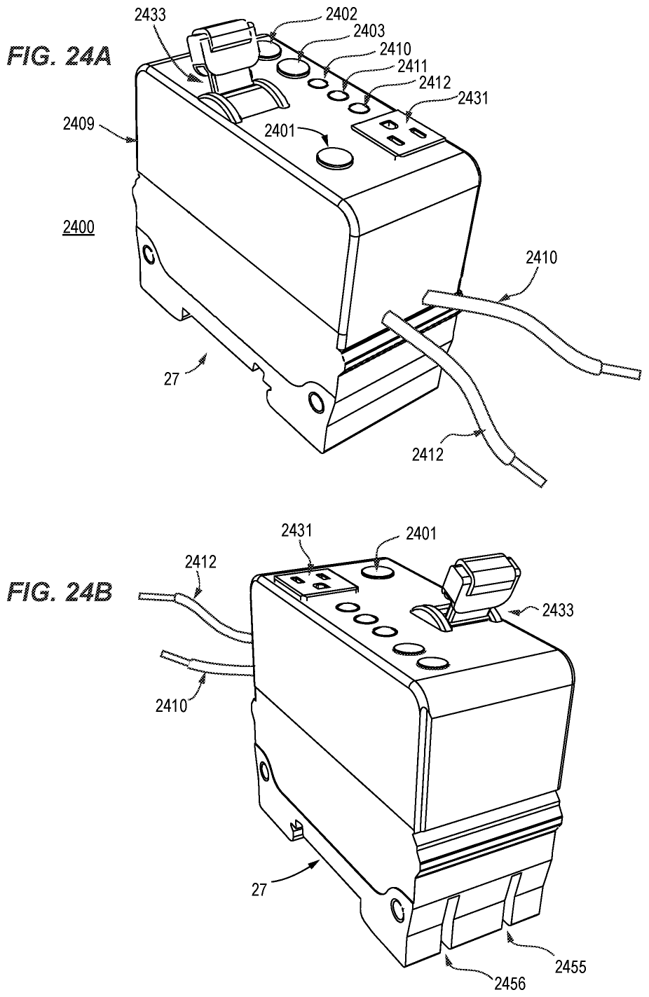

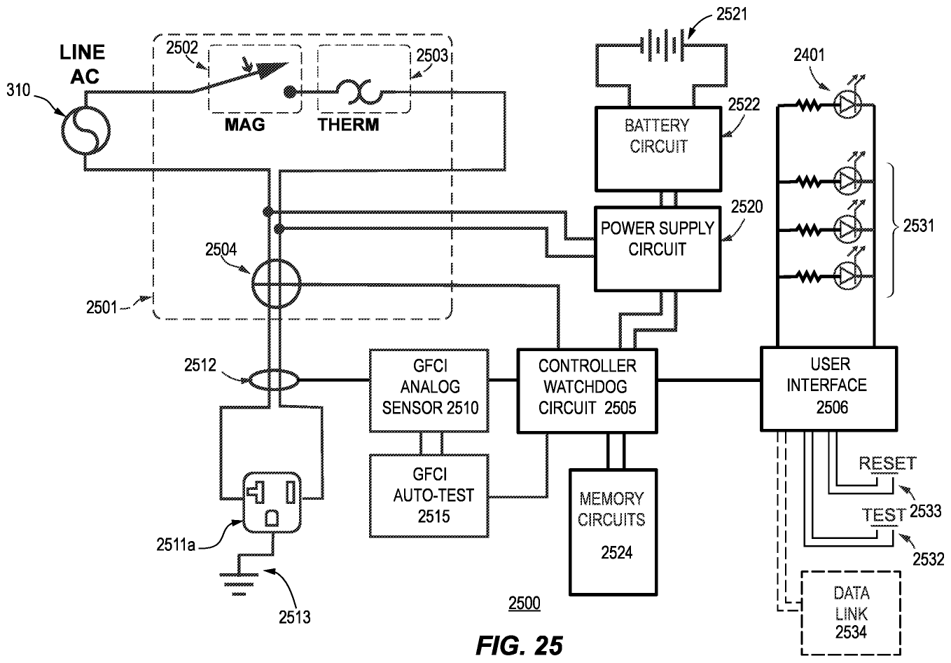

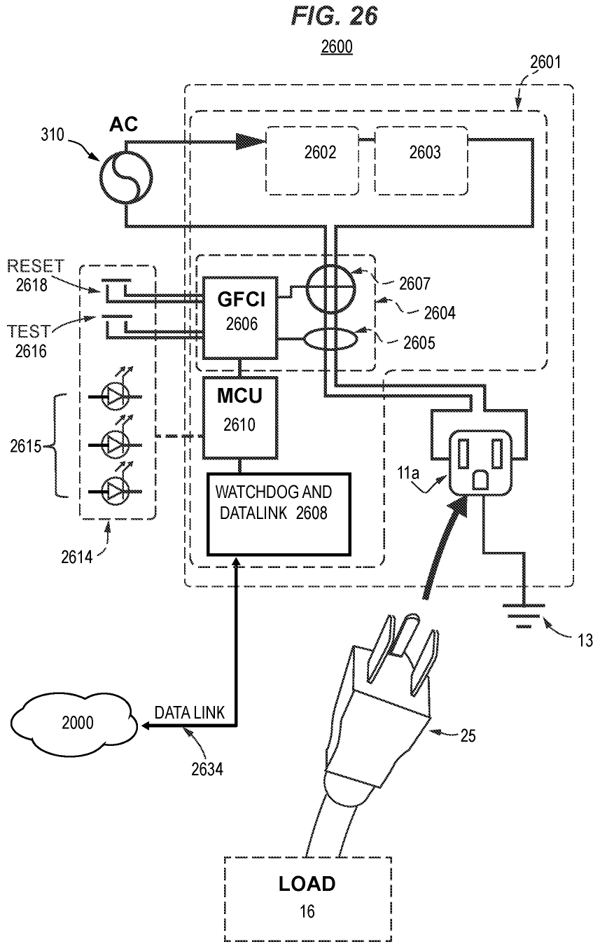

FIGS. 24A and 24B are perspective views of a modular circuit breaker/plug receptacle combination with user interface. Combination device 2400 having a NEMA-style AC plug receptacle, a circuit breaker with thermal, overload and ground fault interrupts, and solid state watchdog circuitry that monitors the breaker status. The device may include communications circuitry configured to report the breaker status to a network. The network may include a cloud host that receives reports and archives the results or generates notifications that are sent to a responsible party if there is a non-compliant status. This double wide device facilitates incorporation of the circuit features shown in FIG. 25 or 26, and also permits incorporation of the various plug receptacle styles shown in FIGS. 18, 20, and 21.

Device 2400 is designed to connect on the underside to a hot bus bar and to be connected to a neutral return and a ground strap by external wires 2410,2412. The details are not fixed because some circuit breaker panels are designed for snap-on neutral connections that eliminate the need for neutral wire 2412. The device includes a plastic body 2409. Molded body devices of this style may also include multiple hot rails for three phase power applications, but in this instance an underside slot 27 for installation on a conventional DIN rail is shown. The device (FIG. 24B) includes two front bottom slots 2455,2456, one of which includes a live hot shoe for receiving power from a hot bus bar when mounted on a DIN rail. For illustration, slot 2456 is described as having a hot shoe that connects the hot feed to the plug receptacle 2431.

GFCI protection is built into the device. Unit 2400 is supplied with ground fault interrupt circuitry coupled to the plug receptacle. While provision of a ground lead 2410 is not strictly required for operation of a GFCI interrupt, the ground lead directs any current leakage through the plug receptacle and to a ground strap in the breaker panel.

A ground fault creates a differential current between the hot conductor 2456 and the neutral conductor 2412. Under normal operating conditions, the current flowing in the hot conductor should equal the current in the neutral conductor. Accordingly, GFCIs are typically configured to sense the differential current between the two conductors. At any instant that the differential current exceeds a predetermined threshold, usually about 6 mA, the GFCI responds by interrupting the circuit. Circuit interruption is typically effected by opening a set of contacts disposed between the source of power and the load. The GFCI or an associated watchdog circuit may also respond by actuating an alarm of some kind in response to a fault. Analogous features may be incorporated to generate alarm conditions for short, thermal overload, and arc fault conditions.

In addition to a conventional plug receptacle 2431 and single throw switch 2433 the uppermost panel of the device may include a user interface that includes a lamp 2401 for illumination of the work area, a reset 2402 and test 2403 switch coupled to the GFCI interrupt, and one or more indicator lamps 2410,2411,2412 that are green when the device is working properly, or otherwise alarm or warn of a fault.

FIG. 25 is a schematic 2500 of a circuit breaker/plug receptacle device with ground fault circuit interrupt, user interface, optional datalink, and battery backup. The circuit includes a magnetic breaker 2502, a thermal breaker 2503, and a ground fault interrupt 2504 with ground fault inductive sensor 2512 and GFCI comparator circuitry 2510 that monitors hot and neutral current through the plug receptacle and trips the circuit interrupt 2504 if the differential current is 6 mA or more, as is the conventional limit for a ground fault interrupt. Ground leakage of less than 4 mA does not trip the breaker. The three circuit interrrupts 2501 are operatively coupled to plug receptacle 2511a, which is shown here with an isolated ground strap 2513. The user interface 2506 may include Test 2532 and Reset 2533 switches.

The ground fault sensor 2510 may be linked to an auto-test circuit 2515. Periodic testing of the GFCI mechanism 2504 is recommended and may be performed automatically on a monthly basis, for example. The GFCI solenoid may be reset using a mechanical lever arm after each test. The watchdog circuit 2505 includes a microcontroller that may execute instructions from a memory circuit or cache 2524 such as would include firmware, EEPROM, or software-encoded instructions. The controller/watchdog circuit 2505 monitors the circuit interrupts 2501 and alarms if a hazard condition develops or a test of the breaker fails. A history of electrical events and fault flags may be stored locally in memory circuit 2524, such as RAM or flash memory, and may be sent to a central monitoring station or cloud host via data link 2534, for example. Any alarm notifications may take the form of a display on the user interface 2506 (such as by providing LEDs 2531 to display device status) or may be sent via data link 2534 for remote monitoring. Data collection may include response time, sensitivity, tolerance, and cutoff thresholds, for example.

The devices include reset features that can be electromechanical, analog or digital, such as lever arms operated by a servo, stepper motor, or winch, or solid state circuit interrupts (not shown) monitored by a digital watchdog, and set or reset with microsecond response time.

A power supply circuit 2520 draws power from the AC line feed to power the logic circuitry. Digital logic circuit power V_{cc} is supplied from a voltage regulator and conditioner downstream from a rectifier. A low dropout (LDO) switching regulator is included in the power supply circuit 2520 to switch the power from AC to battery or from battery to AC as available. For stability of operation and for use in data tracking, a rechargeable battery 2521 and circuit 2522 is included so that clock, alarm, memory, user interface, and data link functions are not interrupted by temporary power failures. The battery recharges from the breaker panel power supply, but is available when line power is interrupted. The battery circuit 2522 can include battery diagnostics circuits (such as weak output) and battery data reporting capacity.

When a breaker panel is used for grid power flow from local power supplies upstream to the grid or from local power supplies to downstream local loads, the integrity of the system during any interruption of grid AC supply becomes an issue that is solved here by including rechargeable battery 2521 and charging circuit 2520,2522. The battery may be sized according to the energy budget of the entire circuit 2500. In addition to duty cycle control of power management, power supply circuit 2520 can include definitions for standby conditions that selectively de-power parts of the circuit. For example, the microcontroller can include a low power state in which only the clock is being powered and a wake monitor is set so that the device can wake up according to a clock signal, or some other digital input that awakens one or more higher processing functions of the device. In some instances, such as when there is a BT radio modem or a CELLULAR radio modem in the breaker device, the modem controllers may be selectively powered to function as networked or ad hoc peer-to-peer “wake radios” or “always listening radios” as a specialized low power operating state that enables the device to be operated from battery power for hours, weeks and even months. A small rechargeable NiCad battery, or a 9V battery such as commonly used in smoke detectors, for example, may suffice for extended use during power interruptions.

The batteries 2521 would not necessarily be large enough to power a downstream load, but may be sufficient to power a radio transmit/receive session for networking during power failures, or a user display of device status even when street power is down. These features may be useful when the device is configured for receiving power via the plug-in cord and for conveying that power to a larger battery that is fed from the breaker panel, for example, during emergency use. The battery may also be used to provide emergency lighting during power failures, and a photocell (not shown) may be used to control lamp 2401. The lamp 2401 (FIG. 24) illuminates the entire breaker panel with a soft white light when needed.

The batteries may also be used to power a speaker (not shown), if the device is configured for function as a cellular radio, (i.e., it has a SIM card, a Cellular modem, and optionally a synthetic radio driver circuit) and may convey voice messages or alarm tones. Addition of a microphone provides the user with a stand-up telephonic service powered at the breaker box with battery reserve backup. In one limited embodiment, the device would provide 911 calling in the event of an electrical injury condition such as a sudden arc or short in the plug receptacle when combined with input to the watchdog circuit of motion sensor data from a sensor mounted on the front panel of the device (not shown) or microphonic inputs from a microphone, as may be processed by a digital signal processor (DSP), with suitable filtering of the raw output of a microphone, or by the microcontroller following A/D conversion.

The watchdog circuitry 2505 may generate monitoring data, including flagged events and alarm conditions. Alarm conditions may be indicated on the device by LEDs 2531. Data may also include a variety of sensor data, include one or more temperature sensors, pressure sensors, current sensors, voltage sensors, impedance sensors, Hall effect sensors, accelerometers, GPS sensors that are radio operated, and any type of network-assisted AGPS or triangulation of signals for generation of location data such as for tracking of inventory and job locations, and one or more of any other type of sensor, without limitation.

Data link 2534 may be connected to an external reporting station or cloud server, for example. The link can be a wired or wireless link, but generally is configured for serial data transfer. The device may include circuitry for processing packet data received or sent in one or more formats. Bluetooth, WiFi and cellular packet data standards differ, but with 5G are increasingly becoming interlinked by edge computing capacity. The devices may include edge computing capacity in the watchdog 2505 or in an enhanced data link engine 2534 with smart algorithms and access to data locally or from remote databases. Surprisingly, Bluetooth radio signals are able to readily penetrate the interference created by the AC sine wave and dampening of the breaker box frame and cover. Alternatively, an ethernet cable or other wired UART databus for example may be used to collect data, prepare reports, and make notifications of any fault or failure in the combined device (or in an appliance that is plugged into plug receptacle 2511a). Plug receptacle 2511a is sometimes referred to as a “T-slot” connector that accepts both a 3-prong 5-15P NEMA mail plug as well as the 5-20P male plug (FIG. 20). These are compatible with 20 Amp breakers. Analogous devices having aviation-type plug connectors are also envisaged.

In another application, the clock of the device microcontroller 2505 can be used to perform a control function such as turning on a plug-in device or turning off a plug-in device.

### Example II: GFCI Device with User Interface, Datalink and Cloud Host

FIG. 26 is a schematic 2600 of a circuit breaker/plug receptacle combination device with user interface 2614 and datalink 2634. Three breaker elements 2602, 2603, 2604 are combined in the device to protect the plug receptacle 11a, and any plug-in appliance 16, from a fault condition. Plug 25 inserts into the plug receptacle during use. The combination device includes a microprocessor or microcontroller with user interface and indicator lamps for local reporting of device status. Circuit 2600 is mounted on a printed circuit board (PCB, 2601) and includes an MCU 2610 that functions in receiving local commands from the user interface 2614 and an optional data link 2634 to an external monitoring system 2000, depicted here as a cloud computing resource, while not limited thereto. Digital logic circuit power V_{cc} is drawn from the AC line 2001 feed by a voltage regulator and conditioner downstream from a rectifier generally as described in FIG. 25.

Breaker element 2602 is a current overload breaker; breaker element 2603 is a thermal overload breaker. The breaker circuit(s) include a GFCI unit 2604 operatively linked to the plug receptacle 2611a. The GFCI unit includes an analog differential current detector (with coil, 2605 and solid state analyzer unit 2606), and an electromechanical trip switch 2607.

Associated with the PCB 2601 is a user interface 2614 that includes a manual switch 2616 for testing and a reset button 2618. Control signals are generated to the microcontroller when the reset and test buttons are pressed. In one embodiment, test button 2616 causes a simulated ground fault. In another embodiment, test button 2616 may be configured to cause the MCU to simulate a fault condition in each of the three circuit interrupts and to assess overall device readiness. By automating testing functions under control of an MCU clock, a significant level of operator relief is achieved from the burden of recommended monthly testing of the GFCI circuit interrupt.

LEDs 2615 serve in displaying device status and may be color coded, for example a bank of green LEDs can indicate proper operation of all the breakers of the device. A flashing LED, or a red light (when using RGB LEDs) can indicate a hazard. In one embodiment, the LEDs continue to function even if one of the breakers has tripped, such as by supplying a battery power reserve as described with reference to FIG. 25, or by drawing inductive power from adjacent circuits in the breaker panel to power the user interface 2614 and MCU 2610. The LED display bank may show status of the appliance or tool 16, for example a ground fault in a tool is detected by device 2600 and may show status of the device 2600 if improperly wired during installation.

By adding networking capacity via datalink 2634, the device can be monitored locally or remotely. By adding a clock, battery and memory, chronological records of events can be stored locally and are available to a technician during servicing. By using solid state breaker elements, the devices can include automated testing during down time or at programmed intervals.

Networking can be to a cloud host 2000, a server in the building, or can be to a local smart device. Generally, any local service capability is backed up by a cloud administrative server and reports are generated or are accessible to users via a remote interface.

### Example III: GFCI Device with Solid State Components

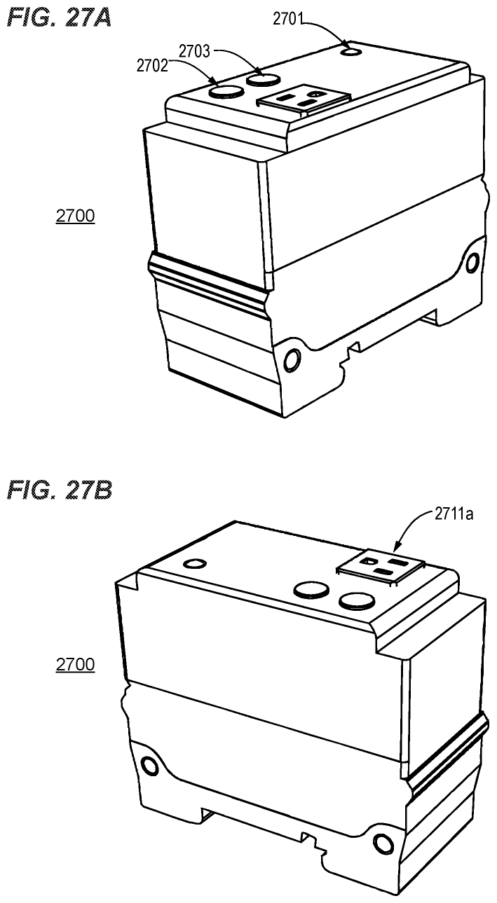

FIGS. 27A and 27B are views of a modular circuit breaker/plug receptacle combination 2700 with solid state components. The combination device includes logic circuitry and a comm circuit for reporting device status to a network. Data from the device is communicated wiredly or wirelessly to a server or local smart device. The circuit breaker device is generally able to operate independently from a server or local smart device, and includes a user interface. An onboard battery backup for operation of the device electronics is contemplated so that it can resume safe operation when power is restored after a temporary power failure.

Indicator LED 2701 may be an RGB LED, and may by illuminated “red” or “green” depending on the status of the circuit. Switch 2702 permits the circuit to be manually tripped (LED goes to blue) and turned back on (LED goes to green or red, depending on circuit breaker status). Switch 2703 permits manual testing of circuit breaker function, for example a simulated ground fault that will cause the GFCI breaker to trip. In some embodiments, switch 2702 will also permit simulation of a short circuit in the load, an arc fault, or a thermal overload, for example. If a breaker trips, switch 2702 allows the user to reset the device manually so that the plug-receptacle goes live again and indicator 2701 illuminates as a green light if the circuit and any plug-in appliance is clear of any fault condition or test event that tripped the breaker.

The device includes a GFCI-protected plug-in receptacle 2711a, shown here with a NEMA plug receptacle, but may also be provided with an aviation-style threaded receptable as has been described for other embodiments such as FIG. 6A. Operatively associated with the plug receptacle is a solid state breaker and associated circuitry for performing a circuit interrupt in the event that a short, thermal overload, and ground fault is detected. Arc fault detection is optionally included and may include arc fault circuit breaker (AFCI) or low-energy arc and ground fault interruptors (CAFCI/GFCI) combination breaker units.

In embodiments, the breaker assembly also may include solid state circuit components (not shown) for monitoring operation, such as a green LED when the circuit is correctly installed and tested to be operating correctly, a blue LED when the circuit is manually tripped but is operating correctly, and a red LED to display a fault, such as a ground fault, arc fault, short, or tripped circuit.

The circuit may include one or more analog or digital sensors. Sensor data outputs may include data indicative of temperature, short, arc, ground leakage, open neutral, current, voltage, inductance and impedance, for example. When networked, a server or local smart device can be programmed to detect patterns in the voltage and current data indicative or predictive of the performance condition of the circuit breakers. Sensor data is linked locally to breaker operation by a watchdog circuit with a processor and an instruction set that operates the breaker. The MCU can be linked to a single solid state breaker that reacts to any of a plurality of fault conditions detected by the one or more sensors. Switch state of user interface switches 2702,2703 is considered to be sensor data, and user commands entered on the user interface are processed according to instructions that are generally stored in local memory.

The device may be monitored or controlled by a local operator, for example from a smartphone, or by a network, for example from a cloud server as part of a smart home network. The device may be recognized and monitored by a smart home network or business smart building server. The control center may include a voice interface, for example. The device may also include a piezo-type speaker to provide an audible warning of overload or fault. The solid state monitoring circuits may be operable even when a load is not connected across plug 2711a.

The solid-state circuit breaker (SSCB) concept works by replacing the conventional electromechanical breaker(s) with power electronics and software or firmware that can trip power to a load with no moving parts. Insulated gate-commutated transistor (IGCT) semiconductor technology is used in one instance. Gate turn-off thyristor (GTO), varistor-linked Zener diode, thermistor, non-linear resistors as surge suppressors, and FET technologies have also been used in combination with separable contacts in older technologies. In one SSCB, a solid state circuit breaker for current interruption is combined with a snubber and metal oxide varistor with a sensor or sensors for flagging one or more fault conditions and a gate driver for opening and closing the circuit breaker gate. Embedded power management software in the device may include predictive algorithms and network reporting capability that are not accessible in conventional circuit breaker technologies.

Digital circuit breakers may include smart algorithms to predict faults before they happen, based on small variances in the AC sine wave. The circuits respond to variations having microsecond timescales and respond in nanoseconds, much more quickly than the millisecond respond expected from traditional GFCI circuit breakers, for example. In one embodiment, each breaker panel is assigned an IP address on a network, and is controlled or monitored remotely from a central server or from a smart device via a and processing power within the panel itself, no external connection to an internet or other external server is needed for basic operation. The primary gain in function with networking is the capacity to store data, to recognize patterns over time, and to make notifications if a trend in the data suggests an imminent fault.

Solid state breakers have another advantage in that they can be tested and reset according to instructions executed by a microcontroller and may not require manual intervention and to be periodically tested. Controllable solid state breaker technology that has been UL approved for commercial use was invented by Atom Power (Huntersville, N.C.) and is the subject of U.S. Pat. Nos. 10,804,692 to Kennedy, and U.S. Pat. Nos. 8,503,138, 8,891,209 for example. These breakers have not yet fully replaced the solenoid-type trip breakers seen in U.S. Pat. No. 4,115,829, but are significantly improved over the solid state circuit interruptors disclosed in U.S. Pat. No. 4,631,621, for example. Newer improvements are described in US Pat. Publ. No US2021/0066013, 2021/0126447 and 2021/0143630. A single solid state breaker can be adapted as a universal circuit interrupt when paired with digital circuitry for detection or prevention of overload, thermal overload, and ground fault conditions in need of a power interrupt. These improvements supplement the manual user interface provided for breaker devices 2700.

### Example IV: GFCI Device with Radio Network Connection

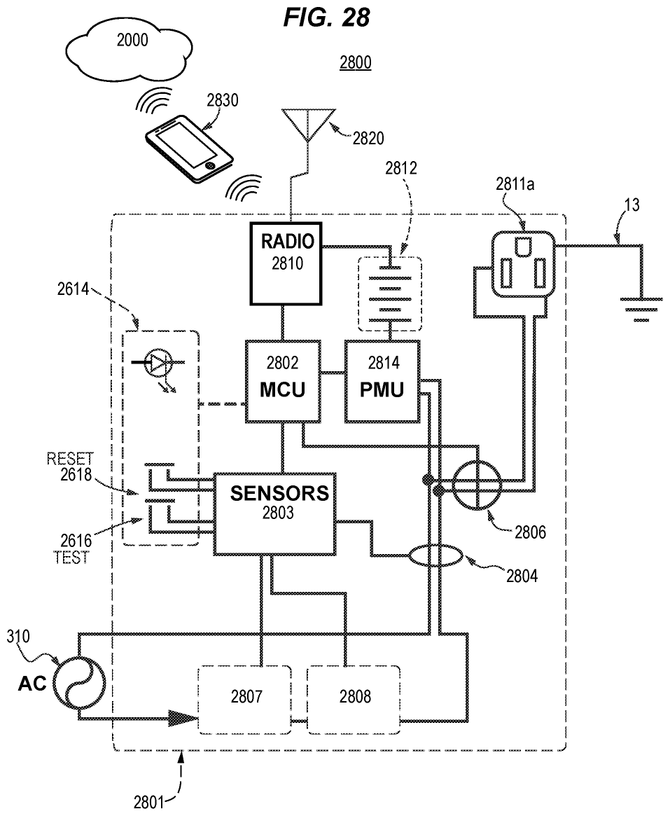

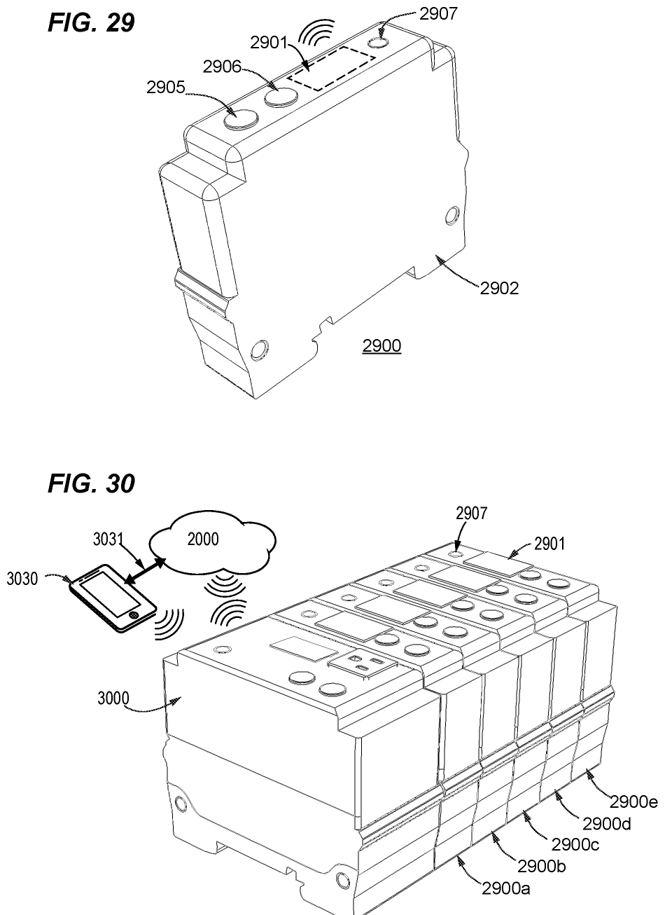

FIG. 28 is a schematic 2800 with system for radio networking of a circuit breaker/plug receptacle combination 2801 with sensors coupled to a processor (MCU, 2802) configured to interrupt power to plug receptacle 2811a when a fault condition exists or is imminent.

Data may be collected by a sensor package 2803, that may include one or more temperature sensors, pressure sensors, current sensors, voltage sensors, impedance sensors, Hall effect sensors, photocells, accelerometers, GPS sensors that are radio operated, any type of network-assisted AGPS or triangulation of signals for generation of location data such as for tracking of inventory and job locations, and one or more of any other type of sensor, without limitation. A ground fault current detector 2804 is also included as a sensor input. Sensors 2807 and 2808 may be current overload and thermal overload sensors, for example. Data from any of the sensor package indicative of a fault condition is processed by MCU 2802 and may result in a command to solid state circuit breaker 2806 that interrupts AC power 310 to the plug-receptacle. In addition, the plug receptacle is independently grounded 13 through the breaker panel.

Switches 2816 (TEST) and 2818 (RESET ON/OFF) of user interface 2814 are also considered to be sensors for purposes of explanation, and generate control signals to MCU 2802 in response to user commands entered on the user interface. Generally, a device identifier and an operating system may be included with the circuit breaker, and is accessible via a datalink. This permits new levels of consolidation of demand management efficiency, mixed energy source switchovers, load balancing, and specialized functions such as powering motor startup that can trip conventional breakers.

In some embodiments, a radio unit 2810 is included. The radio unit is operatively coupled to the processor 2802 for broadcasting state of operation and for receiving control commands. Radio units can include Bluetooth, Cellular, WiFi, ultrawideband (UWB), Zigbee, and other radio standards known in the art.

The radio, processor and sensor package may be powered by a backup battery 2812 under control of a power management unit (PMU, 2814). The power management unit will recharge the battery while connected to line power and includes features for extended operation under battery power in the event of loss of line voltage 310. For example, the microcontroller 2802 can include a low power state in which only the clock is being powered and a wake monitor is set so that the device can wake up according to a clock signal, or some other digital input that awakens one or more processing functions of the device. In some instances, such as when there is a BT radio modem in the device, the modem controller of radio 2810 may be selectively powered to function as networked or ad hoc peer-to-peer “wake radios” or “always listening radios” as a specialized low power operating state that enables the device to be operated from battery power for hours, weeks and even months. A cellular modem may be operated in power savings mode or extended discontinuous receive and transmit to conserve power. A small rechargeable NiCad battery, or a 9V battery such as commonly used in smoke detectors, for example, may suffice for extended use during power interruptions. This ensures that a power surge does not occur when AC power is restored and can also be useful when various renewable power generation technologies such as wind or solar are used to supplement or replace line AC power and require periodic switchovers that may result in fluctuations that would trip conventional circuit breakers.

In one embodiment, the radio 2810 is used as a datalink, and may be a Bluetooth (BT) radio. The radio may communicate wirelessly with a smartphone 2830 or other compatible radio device. The smartphone may collect data from device memory, or operate the device, such as for testing purposes in which the integrity of the overload interrupt, thermal interrupt, arc fault interrupt, or ground fault interrupt is being simulated with millisecond or microsecond response times. The devices include reset features that can be electromechanical, analog or digital, such as lever arms operated by a servo, stepper motor, or winch, or a solid state circuit interrupt 2806 monitored by a digital watchdog, and set or reset with microsecond response time. Logic circuitry supplied in the device may execute self-testing of the GFCI function on a programmable schedule.

The capacity to fully automate testing of the circuit breaker and sensor package is useful in meeting more stringent requirements for periodic testing. Newer UL 943 GFCI standards, for example, may necessitate that GFCI devices test themselves periodically. Although the initial draft standard does not require the device trip its breaker (as would require a manual reset) the device may be required to simulate a ground fault leak and generate a command to trip a breaker in response, even if the solenoid is not actually tripped. Where a solid state breaker is provided, a full test and reset can be performed remotely using a networked breaker device.

In some instances, the radio may communicate with a computing machine that oversees operation of a breaker box and communicates on a channel for receiving data from device 2801 and sending commands to the device. The computing machine may be a local machine such as a smart device, or may be accessed as a cloud resource 2000 which stores performance data, detects trends, and issues commands and notifications based on performance data. Use of a radio link to achieve this level of integration with a network is an advantage over wired connections that require more complex installation and are not readily upgraded. Most radio devices have the capacity to download new software or software patches so that the microcontroller can perform upgrades as needed under control of a system administrator or technician.

Any radio device will include at least one antenna, as will be mounted on or under the faceplate of the device. Surprisingly, BT radio operates smoothly within a closed breaker box in spite of the AC electromagnetic interference and the shielding added by the front cover. Other radio systems that operate in one of the ISM bands or cellular bands may also be incorporated by providing a compatible antenna 2820.

The circuit breaker radio output may also include location data. In one embodiment, GPS is provided as an integrated circuit or built into the radio chip. In other instances, network assisted location services such as AGPS or PoLTE can be enabled. The utility of location services is realized in circuit breakers intended for temporary use at construction sites or for special projects where the location of the device may be needed to retrieve it when the job is finished. A query may be sent to the device that causes the device to execute a location fix and report its position to an operator, or the device may be caused to transmit a signal that enables a network to triangulate its position with a high degree of accuracy.

### Example V: Piconets of Circuit Breakers

In another application, circuit breaker units 2900 are converted to radio-linked devices by adding a Bluetooth patch antenna 2901 that connects to an radio unit and sensor package mounted inside the modular body 2902 and receiving power from the breaker panel (with optional backup battery). These units can include an RGB LED 2907 as a status indicator and may include a reset and test button 2905,2906 These devices may include GFCI circuitry that is tested via radio commands from a hub or from a smart device on a regular basis.

As shown in FIG. 30, these radio devices can be installed in a breaker panel box in radio proximity to a radio-linked circuit breaker/plug receptacle combination hub 3000. “Radio hub” 3000 is the master of a Bluetooth “piconet” that coordinates radio traffic with slaved sticker units and sends summary reports to a cloud host or user device. Each short range BT radio unit communicates with the hub 3000. Each radio unit is assigned a radio unit identifier or UUID consistent with BT piconet radio protocols. The hub in turn is configured to establish a bidirectional radio link with a smart device or some other device capable of reporting data and receiving commands from a network host 2000. For example, as shown in FIG. 30, slave devices 2900a, 2900b, 2900c,2900d and 2900e communicate via BT radio with hub 3000. The Bluetooth piconet operated by a circuit breaker “hub” can extend to other Bluetooth appliances in a household or a vehicle that is in radio proximity to the hub.

More generally, the radio hub 3000 can be a specialized modular device designed to be inserted onto the hot bus bar and wired to receive power from within a breaker panel box. The device can form a BT piconet with up to six breakers 2900 or multiple piconets that have larger numbers of radio breakers. Each radio unit may include a sensor for detecting a proximate flow of alternating current in the breaker, and for detecting fault conditions, for example.

Operation of the breaker box piconet is described in FIG. 30. Device 3000 acts as a hub and is master of the piconet inside the breaker box. A radio antenna is integrated into the modular body of the device. Surprisingly, interference from the AC current is overcome using the Bluetooth digital radio protocol. Smart device 3030, shown here as a smartphone, includes a program that can assist is setup and operation, and can receive notifications 3031 from the hub or from cloud host 2000. Next, the radio protocol identifies the signal from each of the stickers 2900a,2900b,2900c,2900d,2900e,2900f by a unique radio identifier in its signal. The setup program will then send a command to each radio, causing LEDs 2907 to blink blue one at a time, for example, when testing circuitry. The logic circuit in the circuit breakers comprises a processor and processor-executable instructions, which when executed the processor, cause the circuit breaker to tests its fault detection and interrupt functions. The logic circuit may also cause the radio to report system status information to a smart device, cloud host, or a home network, for example.

The system status information can include circuit interrupt event history, logging of current and voltage variability and transients, temperature and humidity in the breaker box, power draw, and also flag events such as return of the family vehicle to a garage or a grid power failure that leads to a switchover to generator power, for example. Any flag can result in an immediate notification to a designated smart device or cloud host. For example, arrival or departure of a vehicle in a garage, as detected by radio signals from the vehicle, can result in coordinated activation or deactivation of smart home circuits. Applications for remote monitoring and/or control of a spider box at a construction site are anticipated.

Interestingly, in one application, the hub can serve as a “lighthouse radiobeacon” that transmits a periodic beacon signal indicative of location. That signal can be used to control features that coordinate a smart home with a smart vehicle depending on whether the vehicle is in the garage or not for example, and can also be used to initiate recharging, updating household notifications for review by a user, facilitating receipt of deliveries, and so forth. The lighthouse beacon may be used to establish a geofence around a house or as a homing beacon, for example and as a radio means for making secure validation of arrivals and deliveries. The hub may serve as a “map pin” that transmits its coordinates as a community service. Other hubs in the home may receive notifications, such as a voice assistant home network can receive a notification when the owner's vehicle returns to the garage. Surprisingly, the effective range of a circuit breaker radio plug 3000 is up to a hundred feet or more despite the metal fireproofing of conventional breaker panels.

The program will evaluate the voltage and current fluctations noted at each of the radio circuit breaker units 2900 and assign each breaker number as a record in a database which identifies the circuit by room of the house or by appliance, such as kitchen, bedroom #1, range, deck lighting, and so forth. Also, if a fault condition develops, such as a tripped circuit breaker, the user will receive a notification. The program can also create calendar reminders to test GFCI circuits periodically, and can report if lights are left on, a stove is left on, and so forth. Also, given that many house fires each year are the result of arc faults in breaker panels or walls, the program can receive arc fault data, current spike, or temperature data from the hub (based on sensors in the devices 2900,3000) and can generate a notification to a user if any arcing condition is detected in a circuit, appliance or plug during use, as may be apparent from an electrical transient.

It is contemplated that articles, apparatus, methods, and processes that encompass variations and adaptations developed using information from the embodiments described herein are within the scope of this disclosure. Adaptation and/or modification of the articles, apparatus, methods, and processes described herein may be performed according to these teachings.

Throughout the description, where articles and apparatus are described as having, including, or comprising specific components, or where processes and methods are described as having, including, or comprising specific steps, it is contemplated that, additionally, there are articles and apparatus that consist essentially of, or consist of, the recited components, and that there are processes and methods that consist essentially of, or consist of, the recited processing steps.

It should be understood that the order of steps or order for performing certain actions is immaterial if the embodiment remains operable. Moreover, two or more steps or actions may be conducted simultaneously.

### INCORPORATION BY REFERENCE

All of the U.S. Patents, U.S. Patent application publications, U.S. Patent applications, foreign patents, foreign patent applications and non-patent publications referred to in this specification and related filings are incorporated herein by reference in their entirety for all purposes.

### SCOPE OF THE CLAIMS

The disclosure set forth herein of certain exemplary embodiments, including all text, drawings, annotations, and graphs, is sufficient to enable one of ordinary skill in the art to practice the invention. Various alternatives, modifications and equivalents are possible, as will readily occur to those skilled in the art in practice of the invention. The inventions, examples, and embodiments described herein are not limited to particularly exemplified materials, methods, and/or structures and various changes may be made in the size, shape, type, number and arrangement of parts described herein. All embodiments, alternatives, modifications and equivalents may be combined to provide further embodiments of the present invention without departing from the true spirit and scope of the invention.

Any original claims that are cancelled or withdrawn during prosecution of the case remain a part of the original disclosure for all that they teach.

In general, in the following claims, the terms used in the written description should not be construed to limit the claims to specific embodiments described herein for illustration, but should be construed to include all possible embodiments, both specific and generic, along with the full scope of equivalents to which such claims are entitled. Accordingly, the claims are not limited in haec verba by the disclosure.

1. An electrical plug outlet mountable within a breaker panel, which comprises
(a) a modular body configured to be mounted in the breaker panel, the body having a superior surface and electrical connections for receiving power from a hot bus bar of the breaker panel;
(b) an operable plug receptacle disposed on the superior surface, the plug receptacle having a ground fault circuit interrupt (GFCI); and,
(c) an electrical ground connection to a ground strap of the breaker panel, wherein the electrical ground is isolated from a neutral bus bar of the breaker panel.

2. The outlet of claim 1, wherein the ground fault circuit interrupt (GFCI) is configured to sense a threshold ground leak current and to trip if the threshold ground leak current is exceeded; and, which comprises a GFCI reset and test button accessible on the superior surface.

3-59. (canceled)

60. A combination breaker/plug device, for use in a breaker panel, which comprises:
(a) a body housing that defines a single-wide modular circuit breaker body member seatable in a single-wide slot on a hot shoe of a hot bus bar in the breaker panel;
(b) disposed in the body housing, a circuit breaker circuit having an operable breaker switch;
(c) disposed in the body housing, a plug receptacle having internal electrical connections for supplying power to an electrical plug in the plug receptacle;
(d) from a first internal electrical connection of the plug receptacle, an internal hot lead connectable to a hot shoe of the breaker panel;
(e) from a second internal electrical connection of the plug receptacle, a neutral lead connectable to neutral bus of the breaker panel;
(f) from a third internal electrical connection of the plug receptacle, a ground lead connectable to a ground strap of the breaker panel; and,
(g) a ground fault circuit interrupt circuit (GFCI) operatively coupled to the internal hot connection and the internal neutral connection.

61. The device of claim 60, wherein the circuit breaker circuit and the GFCI are configured to reversibly interrupt power to the plug receptacle when tripped, and the breaker switch and the plug receptacle are accessible on a user-accessible surface of the body housing when mounted in the breaker panel.

62. The device of claim 60, wherein the plug receptacle is configured to be covered by an unopened exterior door of the breaker panel when an electrical plug is not inserted in the plug receptacle.

63. The device of claim 60, wherein the electrical receptacle is an aviation-type circular connector having two or more pins.

64. The device of claim 60, wherein the electrical receptacle is a NEMA-type receptacle.

65. The outlet of claim 60, wherein the circuit breaker comprises an arc fault interrupt.

66. (canceled)

67. The device of claim 60, wherein the circuit breaker circuit comprises a magnetic interrupt and a thermal interrupt.

68. The device of claim 60, wherein the device is configured to supply power to the plug receptacle when the breaker switch is in a closed position and the GFCI is in an armed position.

69. The device of claim 60, wherein the circuit breaker circuit is a solid state circuit.

70. The device of claim 60, the plug receptacle comprising a hot outlet and a neutral outlet configured to power a load when the load is plugged into the plug receptacle.

71. The device of claim 60, the plug receptacle comprising a ground pin receptacle configured to enable an isolated chassis ground when a load is plugged into the plug receptacle.

72. The device of claim 61, wherein the user-accessible surface comprises a reset switch operably connected to the GFCI circuit.

73. The device of claim 61, wherein the user-accessible surface comprises a test switch operable connected to the GFCI circuit.

74. The device of claim 61, wherein the user-accessible surface comprises one or more indicator displays configured to display a status of the device.

75. The device of claim 61, wherein the user-accessible surface comprises one or more indicator displays configured to display a status of the device when a plug is inserted in the plug receptacle.

76. The device of claim 61, wherein the user-accessible surface comprises one or more indicator displays configured to display a fault status of the device.

77. The device of claim 61, wherein the body housing comprises an bottom face configured to be mounted on a DIN rail inside the breaker panel.

78. The device of claim 60, further comprising a battery and circuit for recharging the battery when line power is supplied to the breaker panel.

79. A combination breaker/plug device for use in a breaker panel, which comprises:
(a) a body housing that defines a single-wide modular circuit breaker body member seatable in a single-wide slot on a hot shoe of a hot bus bar in the breaker panel, the body housing defining a user-accessible surface and a bottom surface when mounted in the breaker panel;
(b) disposed in the body housing, a circuit breaker circuit having a user-accessible breaker switch;
(c) disposed in the body housing on the user-accessible surface thereof, a plug receptacle having internal electrical connections for supplying power to an electrical plug in the plug receptacle;
(d) from a first internal electrical connection in the plug receptacle, an internal hot lead connectable to a hot shoe of the breaker panel;
(e) from a second internal electrical connection in the plug receptacle, a neutral lead connectable to neutral bus of the breaker panel;
(f) from a third internal electrical connection in the plug receptacle, a ground lead connectable to a ground strap of the breaker panel; and,
(g) a ground fault circuit interrupt circuit (GFCI) operatively coupled to the internal hot connection and the internal neutral connection; and,
(h) a battery and a processor configured with instructions for operating one or more functions of the device with power from the breaker panel or from the battery.

80. The device of claim 79, wherein the user-accessible surface comprises one or more indicator displays configured to display a status of the device.

81. The device of claim 79, wherein the user-accessible surface comprises one or more indicator displays configured to display a fault status of the device.

82. The device of claim 79, wherein the battery is maintained in a fully charged state when line power is supplied to the breaker panel.

83. The device of claim 79, wherein the circuit breaker circuit is a solid state circuit.

84. A combination breaker/plug device for use in a breaker panel, which comprises:
(a) a body housing that defines a single-wide modular circuit breaker body member seatable in a single-wide slot on a hot shoe of a hot bus bar in the breaker panel, the body housing defining a user-accessible surface and a bottom surface when mounted in the breaker panel;
(b) disposed in the body housing, a circuit breaker circuit having a user-accessible breaker switch;
(c) disposed in the body housing on the user-accessible surface thereof, a plug receptacle having internal electrical connections for supplying power to an electrical plug in the plug receptacle;
(d) from a first internal electrical connection in the plug receptacle, an internal hot lead connectable to a hot shoe of the breaker panel;
(e) from a second internal electrical connection in the plug receptacle, a neutral lead connectable to neutral bus of the breaker panel;
(f) from a third internal electrical connection in the plug receptacle, a ground lead connectable to a ground strap of the breaker panel; and,
(g) a ground fault circuit interrupt circuit (GFCI) operatively coupled to the internal hot connection and the internal neutral connection;
(h) a rechargeable battery; and,
(i) a Bluetooth radio modem configured with instructions to operate one or more functions of the device while powered from the breaker panel or from the battery, and to transmit radio signals through the breaker panel to an external radio unit.

85. The device of claim 84, wherein the Bluetooth radio is a transceiver enabled to transmit and receive Bluetooth radio signals to and from an external radio unit.

86. The device of claim 84, wherein the battery is a backup battery and is maintained in a fully charged state when line power is supplied to the breaker panel.

87. The device of claim 84, wherein the circuit breaker circuit is configured to be wirelessly reset.

88. The device of claim 84, wherein the circuit breaker circuit is a solid state circuit.

89. The device of claim 84, further comprising one or more sensors, and wherein the device is configured to log system status information collected by the sensor or sensors and to transmit system status information to an external hub, a smart device or a network.

90. The device of claim 84, wherein the instructions includes an instruction which, when executed, causes the device to self-test the ground fault circuit interrupt.

91. The device of claim 84, wherein the device is configured to transmit a radio identification number and data indicative of the operational status of the device to a hub, a smart device, or a network.

92. The device of claim 85, wherein the device is configured to accept a command from a smart device, a network, or a cloud administrative host.
